(19) United States
(12) Patent Application Publication
(10) Pub. No.: US 2022/0244164 A1
(43) Pub. Date: Aug. 4, 2022

(54) OPTICAL MEASURING DEVICE AND OPTICAL MEASURING SYSTEM

(71) Applicants: SONY GROUP CORPORATION, TOKYO (JP); SONY SEMICONDUCTOR SOLUTIONS CORPORATION, KANAGAWA (JP)

(72) Inventors: TOSHIYUKI NISHIHARA, KANAGAWA (JP); MASAAKI HARA, TOKYO (JP); TSUTOMU MARUYAMA, TOKYO (JP); NOBUHIRO HAYASHI, TOKYO (JP)

(21) Appl. No.: 17/612,785

(22) PCT Filed: May 11, 2020
(86) PCT No.: PCT/JP2020/018848

§ 371 Date: Nov. 19, 2021

(30) Foreign Application Priority Data
May 30, 2019 (JP) 2019-101732

(51) Int. Cl. G01N 15/14

(52) U.S. Cl. CPC G01N 15/1434; G01N 2015/1438; G01N 2015/1443

(57) ABSTRACT

Detection omission is reduced. An optical measuring device according to an embodiment includes: a plurality of excitation light sources (32A to 32D) that irradiates a plurality of positions on a flow path through which a specimen flows with excitation rays having different wavelengths; and a solid-state imaging device (34) that receives a plurality of fluorescent rays emitted from the specimen passing through each of the plurality of positions, in which the solid-state imaging device includes: a pixel array unit (91) in which a plurality of pixels is arrayed in a matrix; and a plurality of first detection circuits (93) connected to a plurality of pixels not adjacent to each other in the same column of the pixel array unit, respectively.

### FIELD

The present disclosure relates to an optical measuring device and an optical measuring system.

### BACKGROUND

A flow cytometer has attracted attention as an optical measuring device that wraps a specimen such as a cell with a sheath flow, causes the specimen to pass through a flow cell, irradiates the specimen with laser light or the like, and acquires characteristics of each specimen from a scattered ray or an excited fluorescent ray.

The flow cytometer can quantitatively examine a large amount of specimen in a short time, and can detect various specimen abnormalities, viral infection, and the like by attaching various fluorescent labels to the specimen, including blood cell counting. In addition, for example, by using, as a specimen, one obtained by attaching an antibody or deoxyribo nucleic acid (DNA) to magnetic beads, the flow cytometer is also applied to antibody examination and DNA examination.

Such a fluorescent ray or scattered ray is detected as pulsed light each time an individual specimen passes through a beam spot. Since the intensity of laser light is suppressed so as not to damage the specimen, a side scattered ray and a fluorescent ray are very weak. Therefore, in general, a photomultiplier tube has been used as a detector of such a light pulse.

In addition, in recent years, a so-called multispot type flow cytometer has been developed which emits excitation rays having different wavelengths to different positions on a flow path through which a specimen flows and observes a fluorescent ray emitted due to each of the excitation rays.

Furthermore, in recent years, a flow cytometer using an image sensor has also been developed instead of a photomultiplier.

### CITATION LIST

### Patent Literature

Patent Literature 1: WO 2017/145816 A

### SUMMARY

### Technical Problem

However, in a case where a single image sensor is used as a light receiving unit of a multispot type flow cytometer, when a plurality of specimens continuously passes through a laser spot at short intervals, readout from an image sensor cannot catch up with the passage of the specimens, and detection omission occurs disadvantageously.

Therefore, the present disclosure proposes an optical measuring device and an optical measuring system capable of reducing detection omission.

### Solution to Problem

To solve the above-described problem, an optical measuring device according to one aspect of the present disclosure comprises: a plurality of excitation light sources that irradiates a plurality of positions on a flow path through which a specimen flows with excitation rays having different wavelengths; and a solid-state imaging device that receives a plurality of fluorescent rays emitted from the specimen passing through each of the plurality of positions, wherein the solid-state imaging device includes: a pixel array unit in which a plurality of pixels is arrayed in a matrix; and a plurality of first detection circuits connected to a plurality of pixels not adjacent to each other in the same column of the pixel array unit, respectively.

### BRIEF DESCRIPTION OF DRAWINGS

FIG. 1 is a schematic diagram illustrating an example of a schematic configuration of a single spot type flow cytometer according to a first embodiment.

FIG. 2 is a schematic diagram illustrating an example of a spectroscopic optical system in FIG. 1.

FIG. 3 is a schematic diagram illustrating an example of a schematic configuration of a multispot type flow cytometer according to the first embodiment.

FIG. 4 is a diagram illustrating spots of a fluorescent ray formed in an image sensor when the flow cytometer illustrated in FIG. 3 is not a spectral type.

FIG. 5 is a diagram illustrating spots of a fluorescent ray formed in an image sensor when the flow cytometer illustrated in FIG. 3 is a spectral type.

FIG. 6 is a block diagram illustrating an example of a schematic configuration of an image sensor according to the first embodiment.

FIG. 7 is a diagram illustrating an example of a positional relationship between a pixel array unit and a detection circuit array in FIG. 6.

FIG. 8 is a diagram illustrating an example of a connection relationship between a pixel and a detection circuit in FIG. 6.

FIG. 9 is a circuit diagram illustrating an example of a circuit configuration of a pixel according to the first embodiment.

FIG. 10 is a cross-sectional view illustrating an example of a cross-sectional structure of the image sensor according to the first embodiment.

FIG. 11 is a timing chart illustrating an example of an operation of the pixel according to the first embodiment.

FIG. 12 is a timing chart illustrating an example of a schematic operation of a multispot type flow cytometer according to the first embodiment.

FIG. 13 is a timing chart for explaining an example of a case where readout of a pixel signal from each pixel fails.

FIG. 14 is a timing chart for explaining an example of an operation according to the first embodiment.

FIG. 15 is a timing chart for explaining an example of an operation according to a modification of the first embodiment.

FIG. 16 is a circuit diagram illustrating an example of a circuit configuration of a pixel according to a second embodiment.

FIG. 17 is a diagram illustrating an example of a positional relationship between a pixel array unit and a detection circuit array according to the second embodiment.

FIG. 18 is a timing chart illustrating an example of a schematic operation of a multispot type flow cytometer according to the second embodiment.

FIG. 19 is a schematic diagram illustrating an example of a schematic configuration of a flow cytometer according to a third embodiment.

FIG. 20 is a timing chart illustrating an example of a schematic operation of the flow cytometer according to the third embodiment.

FIG. 21 is a schematic diagram illustrating an example of a schematic configuration of a flow cytometer according to Modification 1 of the third embodiment.

FIG. 22 is a schematic diagram illustrating an example of a schematic configuration of a flow cytometer according to Modification 2 of the third embodiment.

FIG. 23 is a schematic diagram illustrating an example of a schematic configuration of a flow cytometer according to Modification 3 of the third embodiment.

FIG. 24 is a schematic diagram illustrating an example of a schematic configuration of a flow cytometer according to a fourth embodiment.

FIG. 25 is a timing chart illustrating an example of a schematic operation of the flow cytometer according to the fourth embodiment.

FIG. 26 is a timing chart for explaining an example of an operation according to the fourth embodiment.

FIG. 27 is a diagram illustrating an example of a chip configuration of an image sensor according to a fifth embodiment.

FIG. 28 is a plan view illustrating an example of a planar layout of a light receiving chip in FIG. 27.

FIG. 29 is a plan view illustrating an example of a planar layout of a detection chip in FIG. 27.

FIG. 30 is a cross-sectional view illustrating an example of a first laminated structure according to the fifth embodiment.

FIG. 31 is a cross-sectional view illustrating an example of a second laminated structure according to the fifth embodiment.

FIG. 32 is a cross-sectional view illustrating an example of a third laminated structure according to the fifth embodiment.

FIG. 33 is a cross-sectional view illustrating an example of a fourth laminated structure according to the fifth embodiment.

FIG. 34 is a cross-sectional view illustrating an example of a fifth laminated structure according to the fifth embodiment.

### DESCRIPTION OF EMBODIMENTS

Hereinafter, an embodiment of the present disclosure will be described in detail with reference to the drawings. Note that, in the following embodiments, the same parts are denoted by the same reference numerals, and redundant description will be omitted.

In addition, the present disclosure will be described according to the following item order.

1. First Embodiment

1.1 Example of schematic configuration of single spot type flow cytometer

1.2 Example of schematic configuration of multispot type flow cytometer

1.3 Example of configuration of image sensor

1.4 Example of circuit configuration of pixel

1.5 Example of cross-sectional structure of pixel

1.6 Example of basic operation of pixel

1.7 Example of schematic operation of flow cytometer

1.8 Example of case where readout fails

1.9 Relief method when a plurality of specimens passes during the same accumulation period

1.10 Action and effect

1.11 Modification

2. Second Embodiment

2.1 Example of circuit configuration of pixel

2.2 Example of positional relationship between pixel array unit and detection circuit

2.3 Example of schematic operation of flow cytometer

2.4 Action and effect

3. Third Embodiment

3.1 Example of schematic configuration of flow cytometer

3.2 Example of schematic operation of flow cytometer

3.3 Action and effect

3.4 Modification 1

3.5 Modification 2

3.6 Modification 3

4. Fourth Embodiment

4.1 Example of schematic configuration of flow cytometer

4.2 Example of schematic operation of flow cytometer

4.3 Relief method when a plurality of specimens passes

during the same accumulation period

4.4 Action and effect

5. Fifth Embodiment

5.1 Example of chip configuration

5.2 Example of laminated structure

5.2.1 Example of first laminated structure

5.2.2 Example of second laminated structure

5.2.3 Example of third laminated structure

5.2.4 Example of fourth laminated structure

5.2.5 Example of fifth laminated structure

### 1. First Embodiment

First, a flow cytometer as an optical measuring device and an optical measuring system according to a first embodiment will be described in detail with reference to the drawings.

1.1 Example of Schematic Configuration of Single Spot Type Flow Cytometer

First, a single spot type flow cytometer will be described with an example. Note that the single spot type means that there is one irradiation spot of an excitation ray.

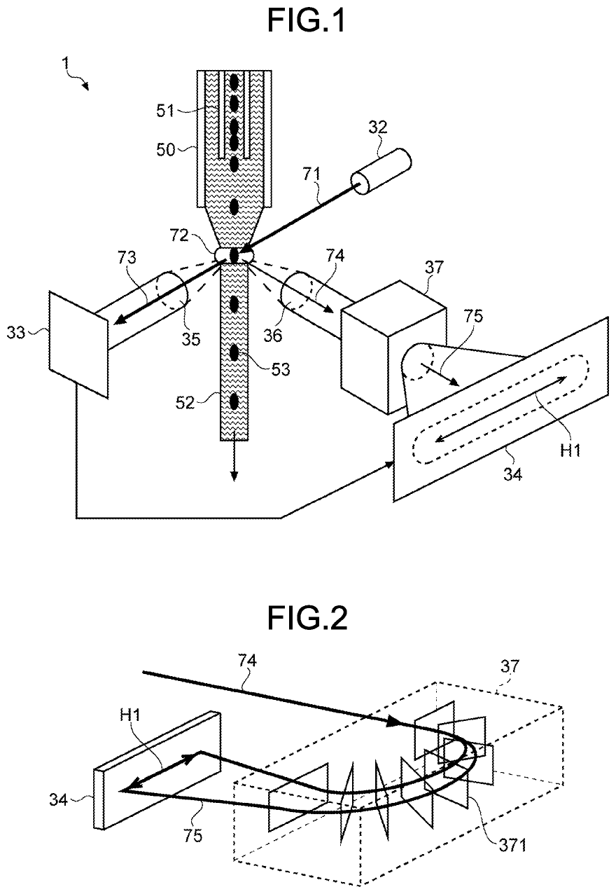

FIG. 1 is a schematic diagram illustrating an example of a schematic configuration of a single spot type flow cytometer according to the first embodiment. FIG. 2 is a schematic diagram illustrating an example of an spectroscopic optical system in FIG. 1.

As illustrated in FIG. 1, a flow cytometer 1 includes a flow cell 50, an excitation light source 32, a photodiode 33, a spectroscopic optical system 37, an individual imaging element (hereinafter, referred to as an image sensor) 34, and condenser lenses 35 and 36.

The cylindrical flow cell 50 is disposed in an upper portion of the drawing, and a sample tube 51 is inserted into the cylindrical flow cell 50 substantially coaxially. The flow cell 50 has a structure in which a sample flow 52 flows down in a downward direction in the drawing, and furthermore, a specimen 53 including a cell and the like is released from the sample tube 51. The specimen 53 flows down in a line on the sample flow 52 in the flow cell 50.

The excitation light source 32 is, for example, a laser light source that emits an excitation ray 71 having a single wavelength, and irradiates an irradiation spot 72 set at a position through which the specimen 53 passes with the excitation ray 71. The excitation ray 71 may be continuous light or pulsed light having a long time width to some extent.

When the specimen 53 is irradiated with the excitation ray 71 at the irradiation spot 72, the excitation ray 71 is scattered by the specimen 53, and the specimen 53, a fluorescent marker attached thereto, or the like is excited.

In the present description, a component directed in a direction opposite to the excitation light source 32 across the irradiation spot 72 among scattered rays scattered by the specimen 53 is referred to as a forward scattered ray 73. Note that the scattered ray also includes a component directed in a direction deviated from a straight line connecting the excitation light source 32 and the irradiation spot 72, and a component directed from the irradiation spot 72 to the excitation light source 32. In the present description, in the scattered ray, a component directed in a predetermined direction (hereinafter, referred to as a side direction) deviated from a straight line connecting the excitation light source 32 and the irradiation spot 72 is referred to as side scattered ray, and a component directed from the irradiation spot 72 to the excitation light source 32 is referred to as a back scattered ray.

In addition, when the excited specimen 53, the fluorescent marker, and the like are de-excited, fluorescent rays each having a wavelength unique to atoms and molecules constituting the excited specimen 53, the fluorescent marker, and the like are emitted from the excited specimen 53, the fluorescent marker, and the like. Note that the fluorescent rays are emitted from the specimen 53, the fluorescent marker, and the like in all directions. However, in the configuration illustrated in FIG. 1, among these fluorescent rays, a component emitted from the irradiation spot 72 in a specific side direction is defined as a fluorescent ray 74 to be analyzed. In addition, the light emitted from the irradiation spot 72 in the side direction includes a side scattered ray and the like in addition to the fluorescent ray. However, in the following, a side scattered ray and the like other than the fluorescent ray 74 are appropriately omitted for simplification of description.

The forward scattered ray 73 that has been emitted from the irradiation spot 72 is converted into parallel light by the condenser lens 35, and then incident on the photodiode 33 disposed on the opposite side to the excitation light source 32 across the irradiation spot 72. Meanwhile, the fluorescent ray 74 is converted into parallel light by the condenser lens 36 and then incident on the spectroscopic optical system 37. Note that each of the condenser lenses 35 and 36 may include another optical element such as a filter that absorbs light having a specific wavelength or a prism that changes a light traveling direction. For example, the condenser lens 36 may include an optical filter that reduces the side scattered ray out of the incident side scattered ray and the fluorescent ray 74.

As illustrated in FIG. 2, the spectroscopic optical system 37 includes, for example, one or more optical elements 371 such as a prism and a diffraction grating, and spectrally disperses the incident fluorescent ray 74 into the dispersed rays 75 emitted at different angles depending on a wavelength. Note that, in the present description, a spreading direction H1 of the dispersed ray 75 is defined as a row direction in a pixel array unit 91 of an image sensor 34 described later.

The dispersed ray 75 emitted from the spectroscopic optical system 37 is incident on the image sensor 34. Therefore, the dispersed rays 75 having different wavelengths depending on a position in a direction H1 are incident on the image sensor 34.

Here, while the forward scattered ray 73 is light having a large light amount, the side scattered ray and the fluorescent ray 74 are weak pulsed light generated when the specimen 53 passes through the irradiation spot 72. Therefore, in the present embodiment, by observing the forward scattered ray 73 by the photodiode 33, a timing when the specimen 53 passes through the irradiation spot 72 is detected.

For example, the photodiode 33 is disposed at a position slightly deviated from a straight line connecting the excitation light source 32 and the irradiation spot 72, for example, at a position on which the excitation ray 71 that has passed through the irradiation spot 72 is not incident or at a position where the intensity is sufficiently reduced. The photodiode 33 observes incidence of light all the time. When the specimen 53 passes through the irradiation spot 72 in this state, the excitation ray 71 is scattered by the specimen 53, and the forward scattered ray 73, which is a component directed in a direction opposite to the excitation light source 32 across the irradiation spot 72, is incident on the photodiode 33. The photodiode 33 generates a trigger signal indicating passage of the specimen 53 at a timing when the intensity of the detected light (forward scattered ray 73) exceeds a certain threshold, and inputs the trigger signal to the image sensor 34.

The image sensor 34 is, for example, an imaging element including a plurality of pixels in which an analog to digital (AD) converter is built in the same semiconductor chip. Each pixel includes a photoelectric conversion element and an amplification element, and photoelectrically converted charges are accumulated in the pixel. A signal reflecting an accumulated charge amount is amplified and output via an amplifying element at a desired timing, and converted into a digital signal by the built-in AD converter.

Note that, in the present description, the so-called spectral type flow cytometer 1 that spectrally disperses the fluorescent ray 74 emitted from the specimen 53 by wavelength has been exemplified. However, the present disclosure is not limited thereto, and for example, can have a configuration in which the fluorescent ray 74 is not spectrally dispersed. In this case, the spectroscopic optical system 37 may be omitted.

In addition, in the present description, the case where the forward scattered ray 73 is used for generating the trigger signal has been exemplified. However, the present disclosure is not limited thereto, and for example, the trigger signal may be generated using the side scattered ray, the back scattered ray, the fluorescent ray, or the like.

1.2 Example of Schematic Configuration of Multispot Type Flow Cytometer

Next, a multispot type flow cytometer according to the first embodiment will be described with an example. Note that the multispot type means that there is a plurality of irradiation spots of an excitation ray.

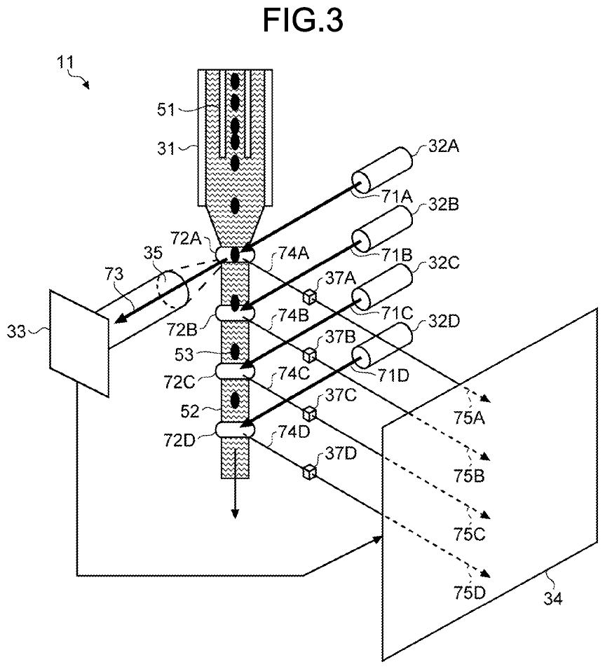

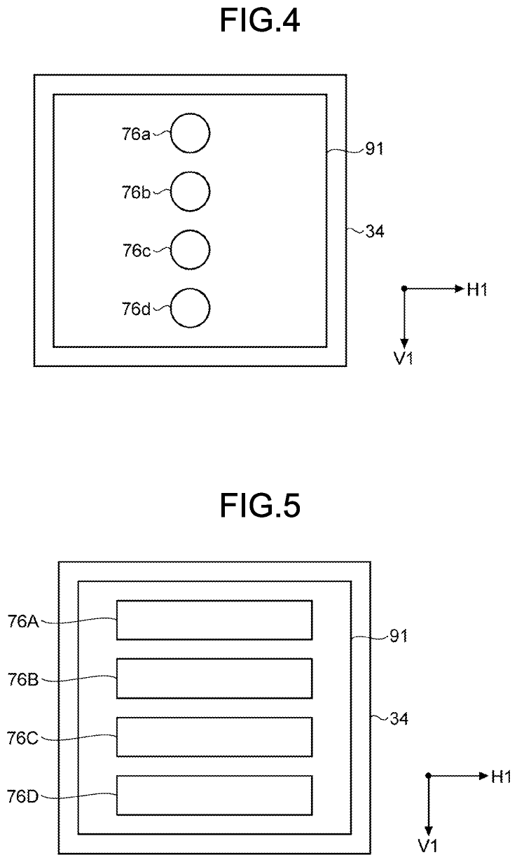

FIG. 3 is a schematic diagram illustrating an example of a schematic configuration of the multispot type flow cytometer according to the first embodiment. Note that, in FIG. 3, the condenser lens 36 that collimates fluorescent rays 74A to 74D emitted from irradiation spots 72A to 72D, respectively is omitted, and spectroscopic optical systems 37A to 37D that spectrally disperse collimated fluorescent rays 74A to 74D, respectively, and dispersed rays 75A to 75D dispersed by the spectroscopic optical systems 37A to 37D, respectively are simplified. In addition, FIG. 4 is a diagram illustrating spots of a fluorescent ray formed in an image sensor when the flow cytometer illustrated in FIG. 3 is not a spectral type, and FIG. 5 is a diagram illustrating spots of a fluorescent ray formed in an image sensor when the flow cytometer is a spectral type.

As illustrated in FIG. 3, a multispot type flow cytometer 11 has a configuration in which one excitation light source 32 is replaced with a plurality of (four in FIG. 3) excitation light sources 32A to 32D that output excitation rays 71A to 71D having different wavelengths in a configuration similar to that of the single spot type flow cytometer 1 described with reference to FIGS. 1 and 2.

The excitation light sources 32A to 32D irradiate different irradiation spots 72A to 72D in the sample flow 52 with the excitation rays 71A to 71D, respectively. The irradiation spots 72A to 72D are arranged at equal intervals along the sample flow 52, for example.

The fluorescent rays 74A to 74D emitted in a side direction from the irradiation spots 72A to 72D, respectively are collimated into parallel light by a condenser lens (corresponding to the condenser lens 36) (not illustrated), and then converted into the dispersed rays 75A to 75D spread in the specific direction H1 by the spectroscopic optical systems 37A to 37D, respectively.

The dispersed rays 75A to 75D are incident on, for example, different regions of the image sensor 34. For example, when the flow cytometer 11 is not a spectral type, that is, when the spectroscopic optical systems 37A to 37D are omitted, as illustrated in FIG. 4, substantially circular fluorescence spots 76a to 76d are formed in the pixel array unit 91 of the image sensor 34 by the fluorescent rays 74A to 74D collimated into parallel light by the condenser lens, respectively. The fluorescence spots 76a to 76d are arrayed at equal intervals in a column direction V1, for example.

Meanwhile, when the flow cytometer 11 is a spectral type, as illustrated in FIG. 5, band-shaped fluorescence spots 76A to 76D are formed in the pixel array unit 91 of the image sensor 34 by the dispersed rays 75A to 75D dispersed in the row direction H1 by the spectroscopic optical systems 37A to 37D, respectively. The fluorescence spots 76A to 76D are arrayed at equal intervals in the column direction V1, for example.

Note that the interval between the fluorescence spots 76a to 76d or 76A to 76D in the column direction V1 can be non-uniform, for example, when a time interval until the specimen 53 that has passed through the irradiation spot on an upstream side passes through a next irradiation spot is specified by a flow rate or the like.

In addition, in FIG. 3, the case where the spectroscopic optical systems 37A to 37D corresponding to the fluorescent rays 74A to 74D on a one-to-one basis are arranged has been exemplified, but the present disclosure is not limited to such a configuration, and a spectroscopic optical system common to a plurality of or all of the fluorescent rays 74A to 74D can be used.

1.3 Example of Configuration of Image Sensor

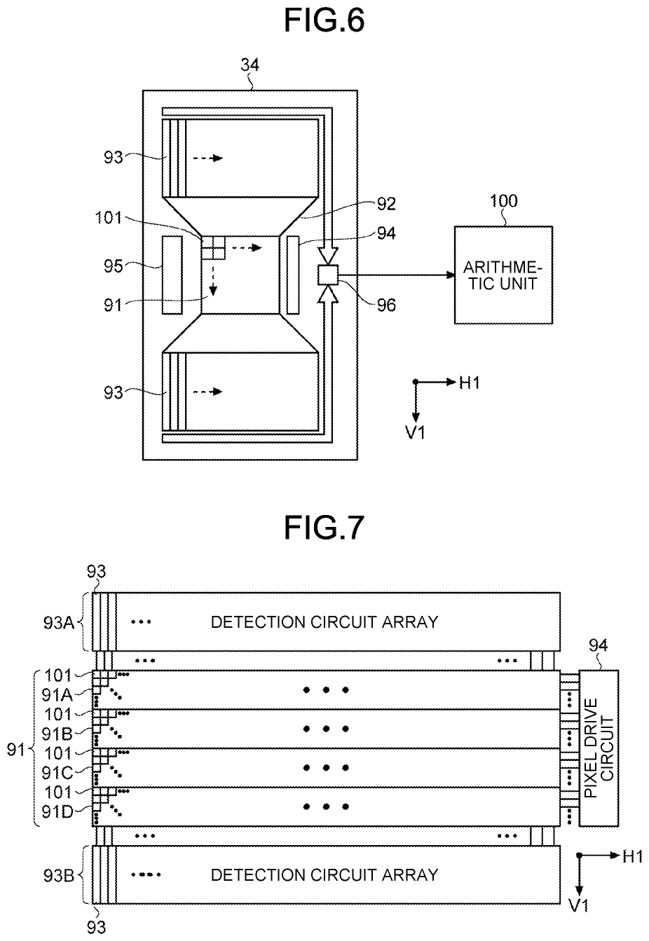

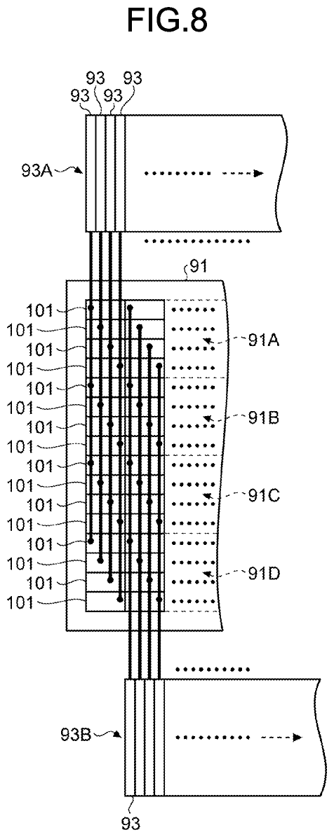

Next, the image sensor 34 according to the first embodiment will be described. FIG. 6 is a block diagram illustrating an example of a schematic configuration of a complementary metal-oxide-semiconductor (CMOS) type image sensor according to the first embodiment. FIG. 7 is a diagram illustrating an example of a positional relationship between a pixel array unit and a detection circuit array in FIG. 6. FIG. 8 is a diagram illustrating an example of a connection relationship between a pixel and a detection circuit in FIG. 6. Note that a case where the flow cytometer 11 is a spectral type will be exemplified below.

Here, the CMOS type image sensor is a solid-state imaging element (also referred to as a solid-state imaging device) formed by applying or partially using a CMOS process. The image sensor 34 according to the first embodiment may be a so-called back surface irradiation type in which an incident surface is on a side opposite to an element formation surface (hereinafter, referred to as a back surface) in a semiconductor substrate, or may be of a so-called front surface irradiation type in which the incident surface is on a front surface side. Note that the size, the number, the number of rows, the number of columns, and the like exemplified in the following description are merely examples, and can be variously changed.

As illustrated in FIG. 6, the image sensor 34 includes the pixel array unit 91, a connection unit 92, a detection circuit 93, a pixel drive circuit 94, a logic circuit 95, and an output circuit 96.

The pixel array unit 91 includes, for example, a plurality of pixels 101 arrayed in a matrix of 240 pixels in the row direction H1 and 80 pixels in the column direction V1 (hereinafter, referred to as 240×80 pixels). The size of each pixel 101 on an array surface may be, for example, 30 μm (micrometers)×30 μm. In this case, an opening of the pixel array unit 91 has a size of 7.2 mm (millimeters)×2.4 mm.

The fluorescent rays 74 emitted from the irradiation spots 72A to 72D in a side direction are collimated by the condenser lens (not illustrated), and then converted into the dispersed rays 75A to 75D by the spectroscopic optical systems 37A to 37D, respectively. Then, the dispersed rays 75A to 75D form the fluorescence spots 76A to 76D in different regions on a light receiving surface on which the pixels 101 of the pixel array unit 91 are arrayed, respectively.

As illustrated in FIG. 7, for example, the pixel array unit 91 is divided into a plurality of regions arrayed in the column direction V1 according to the number of fluorescence spots 76A to 76D to be formed, that is, the number of excitation light sources 32A to 32D. For example, when the number of fluorescence spots to be formed is four (fluorescence spots 76A to 76D), the pixel array unit 91 is divided into four regions 91A to 91D.

The dispersed rays 75A to 75D of the fluorescent rays 74A to 74D emitted from the different irradiation spots 72A to 72D are incident on the regions 91A to 91D, respectively. Therefore, for example, the fluorescence spot 76A by the dispersed ray 75A is formed in the region 91A, the fluorescence spot 76B by the dispersed ray 75B is formed in the region 91B, the fluorescence spot 76C by the dispersed ray 75C is formed in the region 91C, and the fluorescence spot 76D by the dispersed ray 75D is formed in the region 91D.

Each of the regions 91A to 91D includes, for example, a plurality of pixels 101 arrayed in a matrix (hereinafter, referred to as 240×20 pixels) of 240 pixels in the row direction H1 and 20 pixels in the column direction V1. Therefore, when each pixel 101 has a size of 30 μm×30 μm, an opening of each of the regions 91A to 91D has a size of 7.2 mm×0.6 mm.

Among the dispersed rays 75A to 75D, a wavelength component determined by the position in the pixel array unit 91 in the row direction H1 is input to each pixel 101 in each of the regions 91A to 91D. For example, in the positional relationship exemplified in FIG. 2, in the image sensor 34 in FIG. 2, light having a shorter wavelength is incident on a pixel 101 located on a more right side, and light having a longer wavelength is incident on a pixel 101 located on a more left side.

Each pixel 101 generates a pixel signal corresponding to an emitted light amount. The generated pixel signal is read out by the detection circuit 93. The detection circuit 93 includes an AD converter, and converts the analog pixel signal that has been read out into a digital pixel signal.

Here, as illustrated in FIG. 8, one detection circuit 93 is connected to one pixel 101 in each of the regions 91A to 91D. As illustrated in FIGS. 7 and 8, when the pixel array unit 91 is divided into four regions 91A to 91D arrayed in the column direction, one detection circuit 93 is connected to four pixels 101 that are not adjacent to each other in the same column. In this case, a total of 4800 (240×20) detection circuits 93 are arranged with respect to the pixel array unit 91 of 240 pixels×80 pixels. Note that, for simplicity, FIG. 8 illustrates a case where four pixels 101 are arrayed in the column direction in each of the regions 91A to 91D.

Each detection circuit 93, for example, sequentially reads out pixel signals from the plurality of connected pixels 101 in the column direction V1 and performs AD conversion on the pixel signals to generate a digital pixel signal for each pixel 101.

Here, as illustrated in FIGS. 6 to 8, for example, the plurality of detection circuits 93 is arrayed so as to be divided into two groups (detection circuit arrays 93A and 93B) with respect to the pixel array unit 91. One detection circuit array 93A is disposed, for example, on an upper side of the pixel array unit 91 in a column direction, and the other detection circuit array 93B is disposed, for example, on a lower side of the pixel array unit 91 in the column direction. In each of the detection circuit arrays 93A and 93B, the plurality of detection circuits 93 is arrayed in one row or a plurality of rows in a row direction.

For example, the detection circuits 93 of the detection circuit array 93A disposed on an upper side of the pixel array unit 91 in the column direction may be connected to the pixels 101 in even-numbered rows of the pixel array unit 91, and the detection circuits 93 of the detection circuit array 93B disposed on a lower side in the column direction may be connected to the pixels 101 in odd-numbered rows of the pixel array unit 91. However, the present disclosure is not limited thereto, and various modifications may be made, for example, the detection circuits 93 of the detection circuit array 93A may be connected to the pixels 101 in even number columns, and the detection circuits 93 of the detection circuit array 93B may be connected to the pixels 101 in odd number columns. In addition, for example, the plurality of detection circuits 93 may be arrayed in one row or a plurality of rows on one side (for example, an upper side in the column direction) of the pixel array unit 91.

In the pixel array unit 91, 80 pixels 101 are arrayed in the column direction V1. Therefore, it is necessary to arrange 20 detection circuits 93 for one column of pixels. Therefore, as described above, when the detection circuits 93 are classified into two groups of the detection circuit arrays 93A and 93B and the number of rows of each of the groups is set to one, for 80 pixels 101 arranged in one column, it is only required to arrange 10 detection circuits 93 in each of the detection circuit arrays 93A and 93B.

In order to shorten a wiring length from each detection circuit 93 to each pixel 101 as much as possible, it is necessary to set the total value of the widths of the plurality of detection circuits 93 (for example, 10 detection circuits 93 on one side) in the row direction H1 arranged for the pixels 101 in one column to be about the same as or less than the size of the pixels 101 in the row direction H1. In this case, for example, when the size of the pixels 101 in the row direction H1 is 30 μm and the number of the detection circuits 93 arranged for the pixels 101 in one column is 10 on one side, the size of one detection circuit 93 in the row direction H1 can be 3 μm.

A pixel signal read out from each pixel 101 by the detection circuit 93 is converted into a digital pixel signal by the AD converter of each detection circuit 93. Then, the digital pixel signal is output to an external arithmetic unit 100 via the output circuit 96 as image data for one frame.

For example, the arithmetic unit 100 executes processing such as noise cancellation on the input image data. Such an arithmetic unit 100 may be a digital signal processor (DSP), a field-programmable gate array (FPGA), or the like disposed in the same chip as or outside the image sensor 34, or may be an information processing device such as a personal computer connected to the image sensor 34 via a bus or a network.

The pixel drive circuit 94 drives each pixel 101 to cause each pixel 101 to generate a pixel signal. The logic circuit 95 controls drive timings of the detection circuit 93 and the output circuit 96 in addition to the pixel drive circuit 94. In addition, the logic circuit 95 and/or the pixel drive circuit 94 also functions as a control unit that controls readout of a pixel signal with respect to the pixel array unit 91 in accordance with passage of the specimen 53 through each of the plurality of irradiation spots 72A to 72D.

Note that the image sensor 34 may further include an amplifier circuit such as an operational amplifier that amplifies a pixel signal before AD conversion.

1.4 Example of Circuit Configuration of Pixel

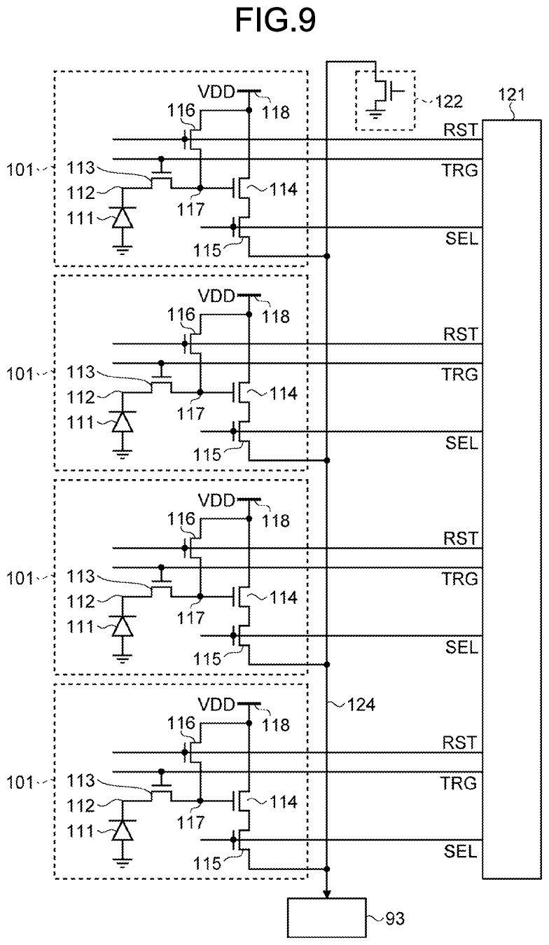

Next, an example of a circuit configuration of the pixel 101 according to the first embodiment will be described with reference to FIG. 9. FIG. 9 is a circuit diagram illustrating an example of a circuit configuration of a pixel according to the first embodiment.

As illustrated in FIG. 9, the pixel 101 includes a photodiode (PD) 111, an accumulation node 112, a transfer transistor 113, an amplification transistor 114, a selection transistor 115, a reset transistor 116, and a floating diffusion (FD) 117. For example, an N-type metal-oxide-semiconductor (MOS) transistor may be used for each of the transfer transistor 113, the amplification transistor 114, the selection transistor 115, and the reset transistor 116.

A circuit including the photodiode 111, the transfer transistor 113, the amplification transistor 114, the selection transistor 115, the reset transistor 116, and the floating diffusion 117 is also referred to as a pixel circuit. In addition, a configuration of the pixel circuit excluding the photodiode 111 is also referred to as a readout circuit.

The photodiode 111 converts a photon into a charge by photoelectric conversion. The photodiode 111 is connected to the transfer transistor 113 via the accumulation node 112. The photodiode 111 generates a pair of an electron and a hole from a photon incident on a semiconductor substrate on which the photodiode 111 itself is formed, and accumulates the electron in the accumulation node 112 corresponding to a cathode. The photodiode 111 may be a so-called embedded type in which the accumulation node 112 is completely depleted at the time of charge discharge by resetting.

The transfer transistor 113 transfers a charge from the accumulation node 112 to the floating diffusion 117 under control of a row drive circuit 121. The floating diffusion 117 accumulates charges from the transfer transistor 113 and generates a voltage having a voltage value corresponding to the amount of the accumulated charges. This voltage is applied to a gate of the amplification transistor 114.

The reset transistor 116 releases the charges accumulated in the accumulation node 112 and the floating diffusion 117 to a power supply 118 and initializes the charge amounts of the accumulation node 112 and the floating diffusion 117. A gate of the reset transistor 116 is connected to the row drive circuit 121, a drain of the reset transistor 116 is connected to the power supply 118, and a source of the reset transistor 116 is connected to the floating diffusion 117.

For example, the row drive circuit 121 controls the reset transistor 116 and the transfer transistor 113 to be in an ON state to extract electrons accumulated in the accumulation node 112 to the power supply 118, and initializes the pixel 101 to a dark state before accumulation, that is, a state in which light is not incident. In addition, the row drive circuit 121 controls only the reset transistor 116 to be in an ON state to extract charges accumulated in the floating diffusion 117 to the power supply 118, and initializes the charge amount of the floating diffusion 117.

The amplification transistor 114 amplifies a voltage applied to the gate and causes the voltage to appear at a drain. The gate of the amplification transistor 114 is connected to the floating diffusion 117, a source of the amplification transistor 114 is connected to a power supply, and the drain of the amplification transistor 114 is connected to a source of the selection transistor 115.

A gate of the selection transistor 115 is connected to the row drive circuit 121, and a drain of the selection transistor 115 is connected to a vertical signal line 124. The selection transistor 115 causes the voltage appearing in the drain of the amplification transistor 114 to appear in the vertical signal line 124 under control of the row drive circuit 121.

The amplification transistor 114 and the constant current circuit 122 form a source follower circuit. The amplification transistor 114 amplifies a voltage of the floating diffusion 117 with a gain of less than 1, and causes the voltage to appear in the vertical signal line 124 via the selection transistor 115. The voltage appearing in the vertical signal line 124 is read out as a pixel signal by the detection circuit 93 including an AD conversion circuit.

The pixel 101 having the above configuration accumulates charges generated by photoelectric conversion therein during a period from a time when the photodiode 111 is reset till a time when the pixel signal is read out. Then, when the pixel signal is read out, the pixel 101 causes a pixel signal corresponding to accumulated charges to appear in the vertical signal line 124.

Note that the row drive circuit 121 in FIG. 9 may be, for example, a part of the pixel drive circuit 94 in FIG. 6, and the detection circuit 93 and the constant current circuit 122 may be each, for example, a part of the detection circuit 93 in FIG. 6.

1.5 Example of Cross-Sectional Structure of Pixel

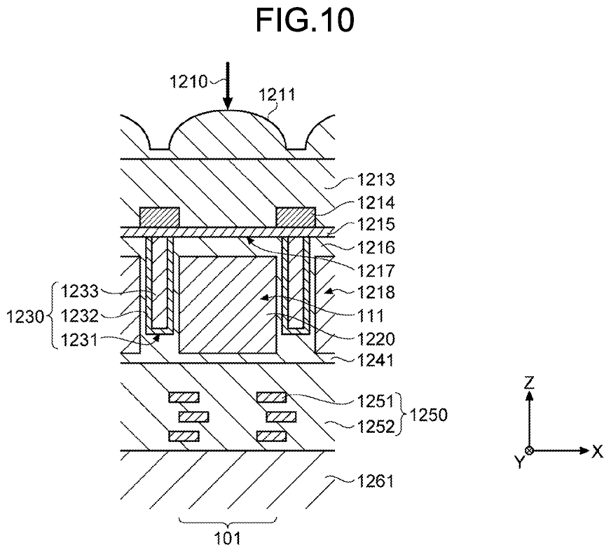

Next, an example of a cross-sectional structure of the image sensor 34 according to the first embodiment will be described with reference to FIG. 10. FIG. 10 is a cross-sectional view illustrating an example of a cross-sectional structure of the image sensor according to the first embodiment. Note that FIG. 10 illustrates an example of a cross-sectional structure of a semiconductor substrate 1218 in which the photodiode 111 in the pixel 101 is formed.

As illustrated in FIG. 10, in the image sensor 34, the photodiode 111 receives incident light 1210 incident from a back surface (upper surface in the drawing) side of the semiconductor substrate 1218. Above the photodiode 111, a planarizing film 1213 and an on-chip lens 1211 are disposed, and the incident light 1210 sequentially incident through each part is received by a light receiving surface 1217, and photoelectric conversion is performed.

For example, in the photodiode 111, an N-type semiconductor region 1220 is formed as a charge accumulation region that accumulates charges (electrons). In the photodiode 111, the N-type semiconductor region 1220 is formed in a region surrounded by P-type semiconductor regions 1216 and 1241 of the semiconductor substrate 1218. The P-type semiconductor region 1241 having a higher impurity concentration than that of the back surface (upper surface) side is formed on a front surface (lower surface) side of the semiconductor substrate 1218 in the N-type semiconductor region 1220. That is, the photodiode 111 has a hole-accumulation diode (HAD) structure, and the P-type semiconductor regions 1216 and 1241 are formed so as to suppress generation of a dark current at an interface between the photodiode 111 and the upper surface side of the N-type semiconductor region 1220 and at an interface between the photodiode 111 and the lower surface side of the N-type semiconductor region 1220.

A pixel isolation portion 1230 that electrically isolates the plurality of pixels 101 from each other is disposed inside the semiconductor substrate 1218, and the photodiode 111 is disposed in a region partitioned by the pixel isolation portion 1230. In the drawing, when the image sensor 34 is viewed from the upper surface side, the pixel isolation portion 1230 is formed in, for example, a lattice shape so as to be interposed between the plurality of pixels 101, and the photodiode 111 is formed in a region partitioned by the pixel isolation portion 1230.

An anode is grounded in each photodiode 111. In the image sensor 34, signal charges (for example, electrons) accumulated by the photodiode 111 are read out via the transfer transistor 113 (not illustrated) (see FIG. 9) and the like, and are output to the vertical signal line 124 (not illustrated) (see FIG. 9) as an electric signal.

A wiring layer 1250 is disposed on the front surface (lower surface) of the semiconductor substrate 1218 opposite to the back surface (upper surface) on which each part such as a light shielding film 1214 or the on-chip lens 1211 is disposed.

The wiring layer 1250 includes a wiring line 1251 and an insulating layer 1252, and is formed such that the wiring line 1251 is electrically connected to each element in the insulating layer 1252. The wiring layer 1250 is a so-called multilayer wiring layer, and is formed by alternately laminating an interlayer insulating film constituting the insulating layer 1252 and the wiring line 1251 a plurality of times. Here, as the wiring line 1251, a wiring line to a transistor for reading out charges from the photodiode 111 such as the transfer transistor 113, and each wiring line such as the vertical signal line 124 are laminated via the insulating layer 1252.

A support substrate 1261 made of a silicon substrate or the like is bonded to a surface of the wiring layer 1250 opposite to the side on which the photodiode 111 is disposed.

The light shielding film 1214 is disposed on a back surface (upper surface in the drawing) side of the semiconductor substrate 1218.

The light shielding film 1214 is formed so as to shield a part of the incident light 1210 traveling from above the semiconductor substrate 1218 toward the back surface of the semiconductor substrate 1218.

The light shielding film 1214 is disposed above the pixel isolation portion 1230 disposed inside the semiconductor substrate 1218. Here, the light shielding film 1214 is disposed so as to protrude in a protruding shape via an insulating film 1215 such as a silicon oxide film on the back surface (upper surface) of the semiconductor substrate 1218. Meanwhile, above the photodiode 111 disposed inside the semiconductor substrate 1218, the light shielding film 1214 is not disposed such that the incident light 1210 is incident on the photodiode 111, and a portion above the photodiode 111 is open.

That is, when the image sensor 34 is viewed from the upper surface side in the drawing, the planar shape of the light shielding film 1214 is a lattice shape, and an opening through which the incident light 1210 passes to the light receiving surface 1217 is formed.

The light shielding film 1214 is made of a light shielding material that shields light. For example, the light shielding film 1214 is formed by sequentially laminating a titanium (Ti) film and a tungsten (W) film. In addition, the light shielding film 1214 can be formed by sequentially laminating a titanium nitride (TiN) film and a tungsten (W) film, for example.

The light shielding film 1214 is covered with the planarizing film 1213. The planarizing film 1213 is made of an insulating material that transmits light. The pixel isolation portion 1230 includes a groove portion 1231, a fixed charge film 1232, and an insulating film 1233.

The fixed charge film 1232 is formed on the back surface (upper surface) side of the semiconductor substrate 1218 so as to cover the groove portion 1231 partitioning the plurality of pixels 101.

Specifically, the fixed charge film 1232 is disposed so as to cover an inner surface of the groove portion 1231 formed on the back surface (upper surface) side of the semiconductor substrate 1218 with a constant thickness. Then, the insulating film 1233 is disposed (filled) so as to fill the inside of the groove portion 1231 covered with the fixed charge film 1232.

Here, the fixed charge film 1232 is formed using a high dielectric having a negative fixed charge such that a positive charge (hole) accumulation region is formed at an interface between the fixed charge film 1232 and the semiconductor substrate 1218 to suppress generation of a dark current. Since the fixed charge film 1232 is formed so as to have a negative fixed charge, an electric field is applied to the interface between the fixed charge film 1232 and the semiconductor substrate 1218 by the negative fixed charge, and the positive charge (hole) accumulation region is formed.

The fixed charge film 1232 can be formed of, for example, a hafnium oxide film (HfO₂ film). In addition, the fixed charge film 1232 can be formed so as to contain at least one of oxides of hafnium, zirconium, aluminum, tantalum, titanium, magnesium, yttrium, and lanthanoid elements, for example.

1.6 Example of Basic Operation of Pixel

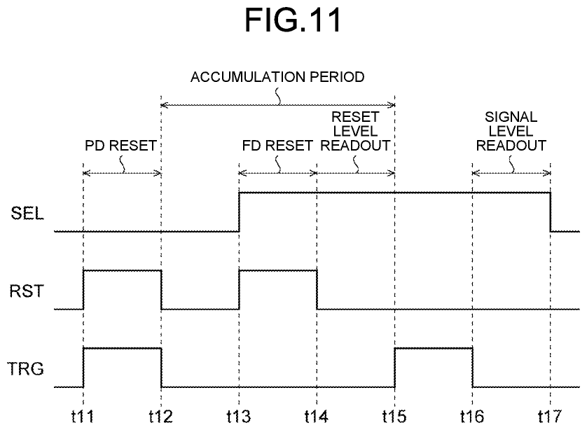

Next, an example of a basic operation of the pixel 101 according to the first embodiment will be described with reference to a timing chart of FIG. 11. FIG. 11 is a timing chart illustrating an example of an operation of the pixel according to the first embodiment.

As illustrated in FIG. 11, in an operation of reading out a pixel signal from each pixel 101, first, a reset signal RST supplied from the row drive circuit 121 to a gate of the reset transistor 116 and a transfer signal TRG supplied from the row drive circuit 121 to a gate of the transfer transistor 113 are set to a high level in a period of timings t11 to t12. As a result, an accumulation node 112 corresponding to a cathode of the photodiode 111 is connected to a power supply 118 via the transfer transistor 113 and the reset transistor 116, and charges accumulated in the accumulation node 112 are discharged (reset). In the following description, this period (t11 to t12) is referred to as photodiode (PD) reset.

At this time, since a floating diffusion 117 is also connected to the power supply 118 via the transfer transistor 113 and the reset transistor 116, charges accumulated in the floating diffusion 117 are also discharged (reset).

The reset signal RST and the transfer signal TRG fall to a low level at timing t12. Therefore, a period from timing t12 till timing t15 at which the transfer signal TRG next rises is an accumulation period in which a charge generated in the photodiode 111 is accumulated in the accumulation node 112.

Next, during a period of timings t13 to t17, the selection signal SEL applied from the row drive circuit 121 to the gate of the selection transistor 125 is set to a high level. As a result, a pixel signal can be read out from the pixel 101 in which the selection signal SEL is set to a high level.

In addition, during the period of timings t13 to t14, the reset signal RST is set to a high level. As a result, the floating diffusion 117 is connected to the power supply 118 via the transfer transistor 113 and the reset transistor 116, and charges accumulated in the floating diffusion 117 are discharged (reset). In the following description, this period (t13 to t14) is referred to as FD reset.

After the FD reset, a voltage in a state where the floating diffusion 117 is reset, that is, in a state where a voltage applied to the gate of the amplification transistor 114 is reset (hereinafter, referred to as a reset level) appears in the vertical signal line 124. Therefore, in the present operation, for the purpose of noise removal by correlated double sampling (CDS), by driving the detection circuit 93 during a period of timings t14 to t15 when the reset level appears in the vertical signal line 124, a pixel signal at the reset level is read out and converted into a digital value. Note that, in the following description, readout of the pixel signal at the reset level is referred to as reset sampling.

Next, during a period of timings t15 to t16, the transfer signal TRG supplied from the row drive circuit 121 to the gate of the transfer transistor 113 is set to a high level. As a result, charges accumulated in the accumulation node 112 during the accumulation period are transferred to the floating diffusion 117. As a result, a voltage having a voltage value corresponding to the amount of charges accumulated in the floating diffusion 117 (hereinafter, referred to as a signal level) appears in the vertical signal line 124. Not that, in the following description, the transfer of the charges accumulated in the accumulation node 112 to the floating diffusion 117 is referred to as data transfer.

As described above, when the signal level appears in the vertical signal line 124, by driving the detection circuit 93 during a period of timings t16 to t17, a pixel signal at the signal level is read out and converted into a digital value. Then, by executing a CDS process of subtracting the pixel signal at the reset level converted into a digital value from the pixel signal at the signal level similarly converted into a digital value, a pixel signal of a signal component corresponding to an exposure amount to the photodiode 111 is output from the detection circuit 93. Note that, in the following description, readout of the pixel signal at the signal level is referred to as data sampling.

1.7 Example of Schematic Operation of Flow Cytometer

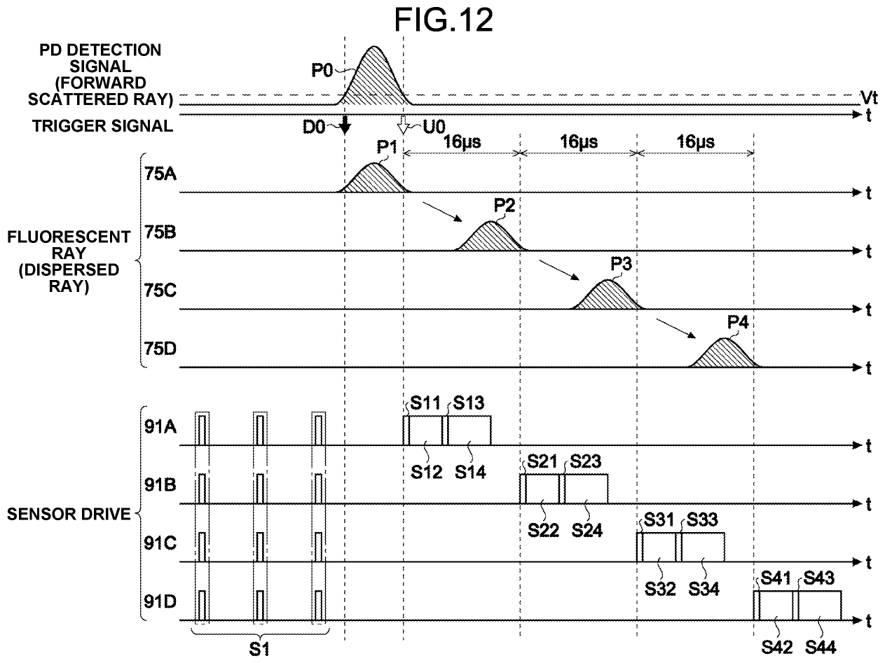

Next, a schematic operation of a flow cytometer according to the first embodiment will be described with an example. FIG. 12 is a timing chart illustrating an example of a schematic operation of the multispot type flow cytometer according to the first embodiment.

Note that, in the timing charts illustrated in FIG. 12 and the following drawings, a detection signal of the forward scattered ray 73 or the like output from the photodiode 33 or the like (hereinafter, referred to as a PD detection signal) is indicated at an uppermost part, an example of a trigger signal generated on the basis of the PD detection signal is indicated at a next highest part, examples of the fluorescent ray 74 or the fluorescent rays 74A to 74D (actually, the dispersed ray 75 of the fluorescent ray 74 or the dispersed rays 75A to 75D of the fluorescent rays 74A to 74D) incident on the pixel array unit 91 or the regions 91A to 91D of the pixel array unit 91 are indicated at a next highest part, and a drive example of the image sensor 34 or a drive example of each of the regions 91A to 91D of the image sensor 34 is indicated at a lowermost part.

In addition, in the present description, a case where the irradiation spots 72A to 72D are arranged at equal intervals along the sample flow 52, and a time interval until the specimen 53 that has passed through an irradiation spot on an upstream side passes through a next irradiation spot is 16 μs will be exemplified.

As illustrated in FIG. 12, in the flow cytometer 11, a reset signal S1 (corresponding to the above-described reset signal RST and transfer signal TRG) that resets the photodiode 111 of the image sensor 34 is output at a predetermined cycle (for example, 10 to 100 μs (microseconds)) during a period in which the forward scattered ray 73 is not detected by the photodiode 33. That is, during the period in which the forward scattered ray 73 is not detected by the photodiode 33, the PD reset for each pixel 101 is periodically executed.

Thereafter, when the forward scattered ray 73 is incident on the photodiode 33 due to passage of the specimen 53 through the irradiation spot 72A, the photodiode 33 generates an on-edge trigger signal D0 at a timing when a PD detection signal P0 exceeds a predetermined threshold Vt, and inputs the on-edge trigger signal D0 to the image sensor 34.

The image sensor 34 to which the on-edge trigger signal D0 is input stops periodic supply of the reset signal S1 to the pixel 101, and in this state, waits until the PD detection signal P0 detected by the photodiode 33 exceeds the predetermined threshold Vt. When the supply of the reset signal S1 immediately before the stop is completed, a charge accumulation period starts in each pixel 101 of the image sensor 34. Note that the threshold Vt may be the same as or different from the threshold Vt for generating the on-edge trigger signal D0.

Thereafter, the photodiode 33 generates an off-edge trigger signal U0 at a timing when the PD detection signal P0 exceeds the predetermined threshold Vt, and inputs the off-edge trigger signal U0 to the image sensor 34.

In addition, while the specimen 53 is passing through the irradiation spot 72A, the dispersed ray 75A of the fluorescent ray 74A emitted from the specimen 53 passing through the irradiation spot 72A is incident on the region 91A of the image sensor 34 as a pulse P1 together with incidence of the forward scattered ray 73 on the photodiode 33. Here, in the image sensor 34, as described above, when the on-edge trigger signal D0 preceding the off-edge trigger signal U0 is input to the image sensor 34, the supply of the reset signal S1 is stopped, and the accumulation period starts. Therefore, while the specimen 53 is passing through the irradiation spot 72A, charges corresponding to the light amount of the pulse P1 are accumulated in the accumulation node 112 of each pixel 101 in the region 91A.

When the off-edge trigger signal U0 is input to the image sensor 34, the image sensor 34 first sequentially executes FD reset S11, the reset sampling S12, data transfer S13, and data sampling S14 for each pixel 101 in the region 91A. As a result, a spectral image of the dispersed ray 75A (that is, fluorescent ray 74A) is read out from the region 91A. Hereinafter, a series of operations from the FD reset to the data sampling is referred to as a readout operation.

In addition, the dispersed rays 75B to 75D are incident on the regions 91B to 91D of the image sensor 34 as pulses P2 to P4 in accordance with passage of the specimen 53 through the irradiation spots 72B to 72D, respectively. Here, according to the assumption described above, a time interval at which the same specimen 53 passes through the irradiation spots 72A to 72D is 16 μs.

Therefore, the image sensor 34 executes a readout operation (FD reset S21 to data sampling S24) on the pixel 101 in the region 91B 16 μs after the timing when the FD reset S11 starts for the pixel 101 in the region 91A.

Similarly, the image sensor 34 executes a readout operation (FD reset S31 to data sampling S34) on the pixel 101 in the region 91C 16 μs after the timing when the FD reset S21 starts for the pixel 101 in the region 91B, and further executes a readout operation (FD reset S41 to data sampling S44) on the pixel 101 in the region 91D 16 μs after the timing when the FD reset S31 starts for the pixel 101 in the region 91C.

By the above operation, the spectral images of the fluorescent rays 74B to 74D are read out from the regions 91A to 91D at intervals of 16 μs, respectively.

Then, when the readout of the spectral image from the region 91D is completed and the on-edge trigger signal D0 due to passage of a next specimen 53 is not input, the image sensor 34 supplies the reset signal S1 again and executes periodic PD reset. Meanwhile, when the on-edge trigger signal D0 due to passage of the next specimen 53 is input before the readout of the spectral image from the region 91D is completed, the image sensor 34 executes operations similar to those described above, and thereby reads out the spectral images of the fluorescent rays 74A to 74D from the regions 91A to 91D at intervals of 16 μs, respectively.

1.8 Example of Case where Readout Fails

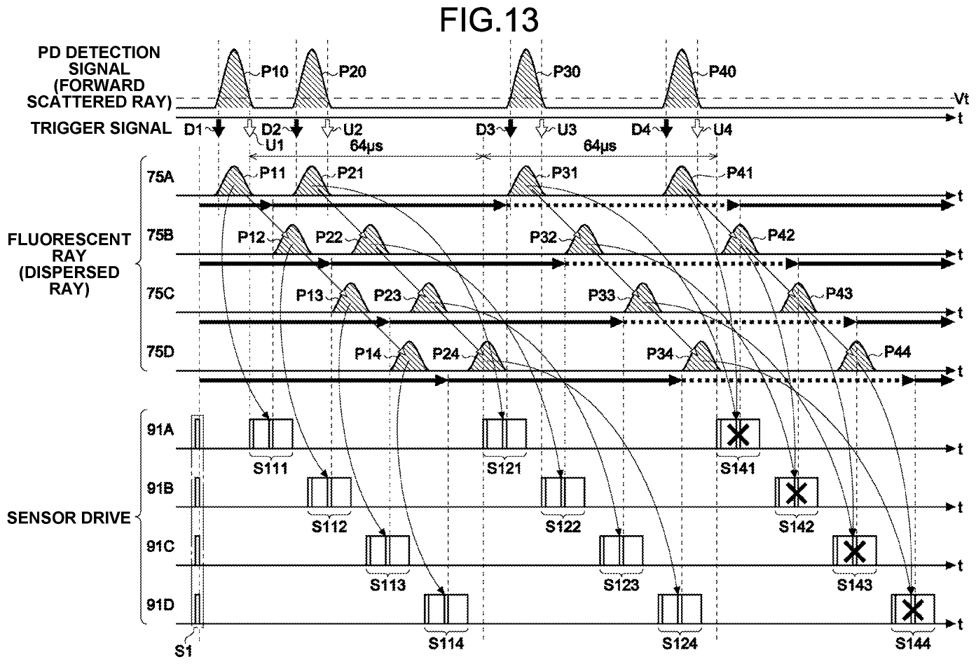

FIG. 13 is a timing chart for explaining an example of a case where readout of a pixel signal from each pixel fails. FIG. 13 illustrates a case where four specimens 53 pass through the irradiation spot 72A in a short period of time. In addition, in FIG. 13, the thick solid arrow or the thick broken arrow indicated along the time axis of a fluorescent ray (dispersed ray) indicates an accumulation period corresponding to each readout operation.

In the example illustrated in FIG. 13, pulses P11 to P14 of the dispersed rays 75A to 75D corresponding to the PD detection signal P10 are read out at intervals of 16 μs by the readout operations S111 to S114, respectively, and pulses P21 to P24 of the dispersed rays 75A to 75D corresponding to the PD detection signal P20 are read out at intervals of 16 μs by the readout operations S121 to S124, respectively.

Here, as assumed above, when the time interval at which the same specimen 53 passes through the irradiation spots 72A to 72D is 16 μs, if the readout operation for each pixel 101 is completed in a time of 16 μs or less, a series of operations of reading out a spectral image from each of the regions 91A to 91D with respect to passage of one specimen 53 can be completed within 64 μs (=16 μs×4). In this case, a frame rate for the entire pixel array unit 91 can be set to, for example, 1 frame/64 μs. Note that, in the following description, an execution period of a series of operations of reading out a spectral image from each of the regions 91A to 91D is referred to as a frame period.

When the frame rate is 1 frame/64 μs, in the example illustrated in FIG. 13, the accumulation period of each pixel 101 with respect to the pulses P21 to P44 after the pulses P11 to P14 immediately after PD reset is 64 μm.

In the example illustrated in FIG. 13, since the pulses P11 to P14 of the specimen 53 that has passed through the irradiation spot 72A immediately after PD reset and the pulses P21 to P24 of the specimen 53 that has passed through the irradiation spot 72A second are incident on the regions 91A to 91D, respectively, in different accumulation periods, a spectral image can be normally read out from each of the regions 91A to 91D.

Meanwhile, pulses P31 to P34 of the specimen 53 that has passed through the irradiation spot 72A third and pulses P41 to P44 of the specimen 53 that has passed through the irradiation spot 72A fourth are incident on the regions 91A to 91D, respectively, during the same accumulation period. Therefore, in readout operations S141 to S144 for the respective regions 91A to 91D, pixel signals corresponding to exposure amounts by the two pulses (pulses P31 and P41, P32 and P42, P33 and P43, and P34 and P44) are read out, and a correct spectral image cannot be acquired. That is, in the example illustrated in FIG. 13, the regions 91A to 91D are doubly exposed by the pulses P31 to P34 of the specimen 53 that has passed through the irradiation spot 72A third and the pulses P41 to P44 of the specimen 53 that has passed through the irradiation spot 72A fourth, and correct spectral images of the third and fourth specimens 53 cannot be acquired (detection omission).

1.9 Relief Method when a Plurality of Specimens Passes During the Same Accumulation Period

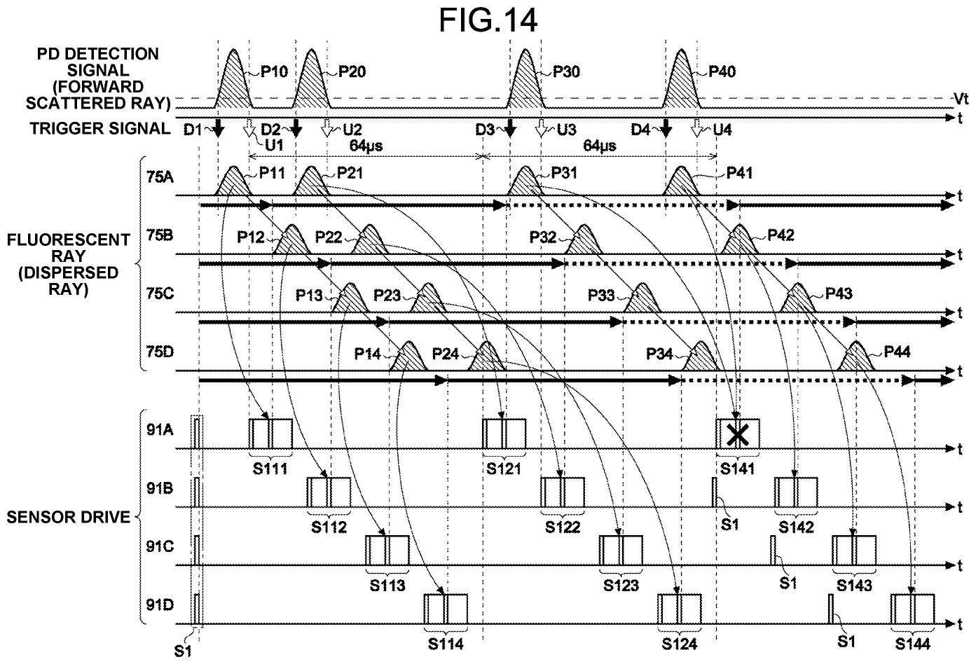

In the present embodiment, in order to reduce detection omission due to a readout failure described with reference to FIG. 13, the following operation is executed. FIG. 14 is a timing chart for explaining an example of an operation according to the first embodiment. As illustrated in FIG. 14, in the first embodiment, for example, when the pulses P31 to P34 and the pulses P41 to P44 are incident on the regions 91A to 91D, respectively, during the same accumulation period as in the PD detection signals P30 and P40 illustrated in FIG. 13 (that is, when double exposure occurs), the row drive circuit 121 of the image sensor 34 outputs a reset signal S1 for performing PD reset on the pixels 101 in each of the regions 91B to 91D before executing read out operations S142 to S144 on the respective regions 91B to 91D.

As described above, by performing PD reset on the pixels 101 immediately before the readout operations S142 to S144, for the regions 91B to 91D, charges accumulated in the accumulation node 112 can be released by irradiation of the previous pulses P32 to P34, and charges by irradiation of the next pulses P42 to P44 can be accumulated in the accumulation node 112. In other words, for the regions 91B to 91D, the exposure period can be interrupted to avoid multiple exposure by two or more pulses. As a result, a spectral image of the fourth specimen 53 can be normally acquired from the regions 91B to 91D.

Note that whether or not a plurality of pulses is incident on each pixel 101 during the same accumulation period can be determined, for example, by determining whether or not two or more on-edge trigger signals or off-edge trigger signals are input from the photodiode 33 during the same frame period by the pixel drive circuit 94 or the logic circuit 95.

In addition, the reset signal S1 when it is determined that a plurality of pulses is incident on each pixel 101 during the same accumulation period may be input from the row drive circuit 121 to the pixels 101 in each of the regions 91B to 91D, for example, immediately before or immediately after an end of the immediately preceding frame period.

1.10 Action and Effect

As described above, according to the present embodiment, when a plurality of pulses is incident on each pixel 101 during the same accumulation period, charges accumulated in the accumulation node 112 are released and the exposure period is interrupted. As a result, for the pixels 101 in the regions 91B to 91D, it is possible to normally acquire a spectral image while avoiding multiple exposure by two or more pulses, and therefore it is possible to reduce detection omission.

1.11 Modification

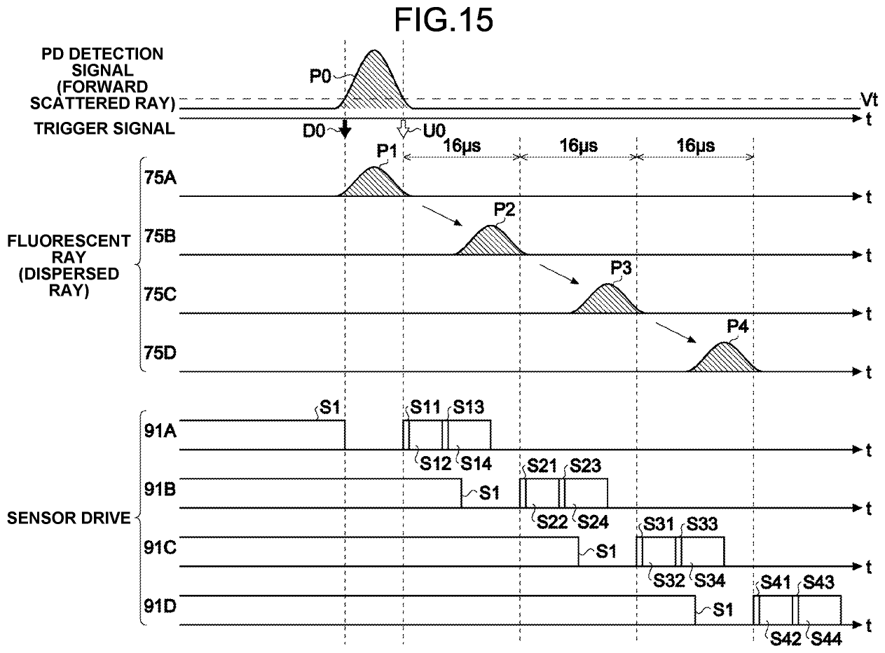

FIG. 15 is a timing chart for explaining an example of an operation according to a modification of the first embodiment.

In the first embodiment described above, during a period in which passage of the specimen 53 through the irradiation spot 72A is not detected, the reset signal S1 is supplied to each pixel 101 at a predetermined cycle, thereby periodically performing PD reset on each pixel 101.

Meanwhile, in the present modification, as illustrated in FIG. 15, the high-level reset signal S1 may be continuously input to the pixel 101 in the region 91A until the on-edge trigger signal D0 of the PD detection signal P0 is input. In addition, the high-level reset signal S1 may be continuously input to the pixels 101 in the regions 91B to 91D in accordance with a time interval (for example, 16 μs) at which the specimen 53 passes through the irradiation spots 72B to 72D.

In this case, a time interval from fall of the reset signal S1 provided to the pixel 101 in the region 91A to fall of the reset signal S1 provided to the pixel 101 in the region 91B is 16 μs. Similarly, a time interval from fall of the reset signal S1 provided to the pixel 101 in the region 91B to fall of the reset signal S1 provided to the pixel 101 in the region 91C is also 16 μs, and a time interval from fall of the reset signal S1 provided to the pixel 101 in the region 91C to fall of the reset signal S1 provided to the pixel 101 in the region 91D is also 16 μs.

By such an operation, the accumulation period of each pixel 101 can be matched with the period in which the pulses P1 to P4 of the dispersed rays 75A to 75D are incident on each pixel 101, and the other periods can be set as reset periods. As a result, charges accumulated in the accumulation node 112 and serving as noise can be released all the time, and therefore a more accurate spectral image can be acquired.

### 2. Second Embodiment

Next, a flow cytometer as an optical measuring device and an optical measuring system according to a second embodiment will be described in detail with reference to the drawings. Note that, in the following description, the same reference numerals are given to similar configurations and operations to those of the above-described embodiment or modifications thereof, and redundant description thereof will be omitted.

The flow cytometer according to the present embodiment may be, for example, similar to the flow cytometer 11 exemplified in the first embodiment. However, in the present embodiment, the pixel 101 in the pixel array unit 91 is replaced with a pixel 201 described later.

2.1 Example of Circuit Configuration of Pixel

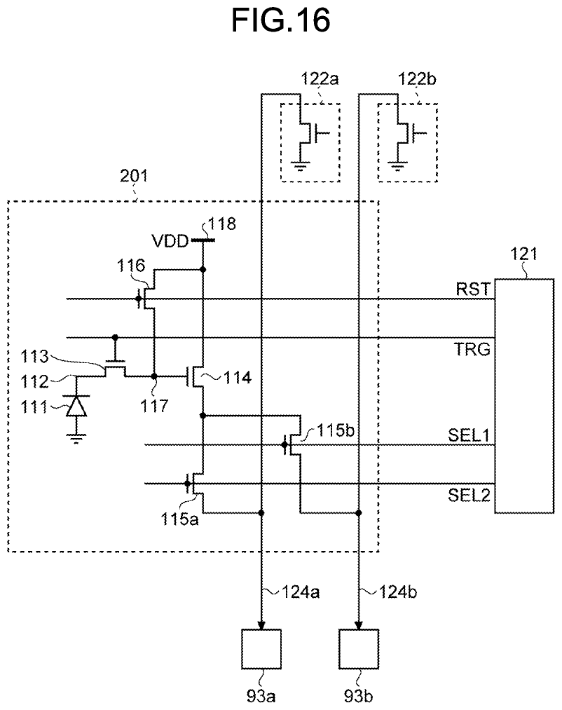

FIG. 16 is a circuit diagram illustrating an example of a circuit configuration of a pixel according to the second embodiment. Note that, in FIG. 16, only one pixel 201 is illustrated, but the number of pixels 201 connected to common vertical signal lines 124a and 124b is not limited to one, and may be two or more, for example, as illustrated in FIG. 9 and the like.

As illustrated in FIG. 16, the pixel 201 has, for example, a configuration in which one selection transistor 115 is replaced with two selection transistors 115a and 115b in a configuration similar to the pixel 101 described with reference to FIG. 9 in the first embodiment.

In addition, in the present embodiment, one vertical signal line 124 is replaced with two vertical signal lines 124a and 124b. A constant current circuit 122a is connected to one end of one vertical signal line 124a, and a detection circuit 93a is connected to the other end thereof. Similarly, a constant current circuit 122b is connected to one end of the other vertical signal line 124b, and a detection circuit 93b is connected to the other end thereof. Note that the detection circuits 93a and 93b may have the same circuit configuration.

In addition, for example, a source of one selection transistor 115a is connected to a drain of an amplification transistor 114, and a drain of the one selection transistor 115a is connected to the vertical signal line 124a. For example, a source of the other selection transistor 115b is connected to the drain of the amplification transistor 114, and a drain of the other selection transistor 115b is connected to the vertical signal line 124b.

The row drive circuit 121 outputs a selection signal SEL1/SEL2 for selecting one of the two selection transistors 115a and 115b, and thereby causes a pixel signal having a voltage value corresponding to the charge amount of charges accumulated in an accumulation node 112 to appear in either one of the vertical signal lines 124a and 124b.

As described above, in the present embodiment, two systems of readout configurations (a configuration including the constant current circuit 122a, the vertical signal line 124a, and the detection circuit 93a, and a configuration including the constant current circuit 122b, the vertical signal line 124b, and the detection circuit 93b) are connected to one pixel 201.

2.2 Example of Positional Relationship Between Pixel Array Unit and Detection Circuit

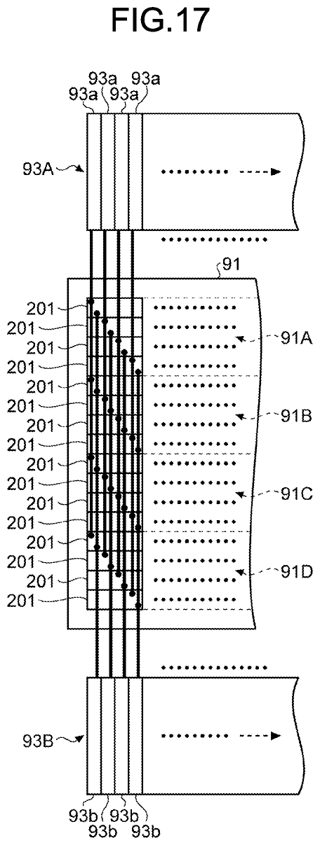

FIG. 17 is a diagram illustrating an example of a positional relationship between a pixel array unit and a detection circuit array according to the second embodiment. As illustrated in FIG. 17, a detection circuit array 93A in which the plurality of detection circuits 93a is arrayed may be arrayed on an upper side of the pixel array unit 91 in the column direction. Similarly, a detection circuit array 93B in which the plurality of detection circuits 93b is arrayed may be arrayed on a lower side of the pixel array unit 91 in the column direction. However, the present disclosure is not limited to such an array, and the plurality of detection circuits 93a and the plurality of detection circuits 93b may be arrayed in two columns on each of an upper side and a lower side of the pixel array unit 91 in the column direction.

As described above, by arraying the detection circuit 93a and the detection circuit 93b connected to the same pixel 201 in the column direction, the two detection circuits 93a and 93b can be connected to each pixel 201 without changing the sizes of the detection circuit array 93A and the detection circuit array 93B in the row direction. Note that, for simplicity, FIG. 17 illustrates a case where four pixels 201 are arrayed in the column direction in each of the regions 91A to 91D.

2.3. Example of Schematic Operation of Flow Cytometer

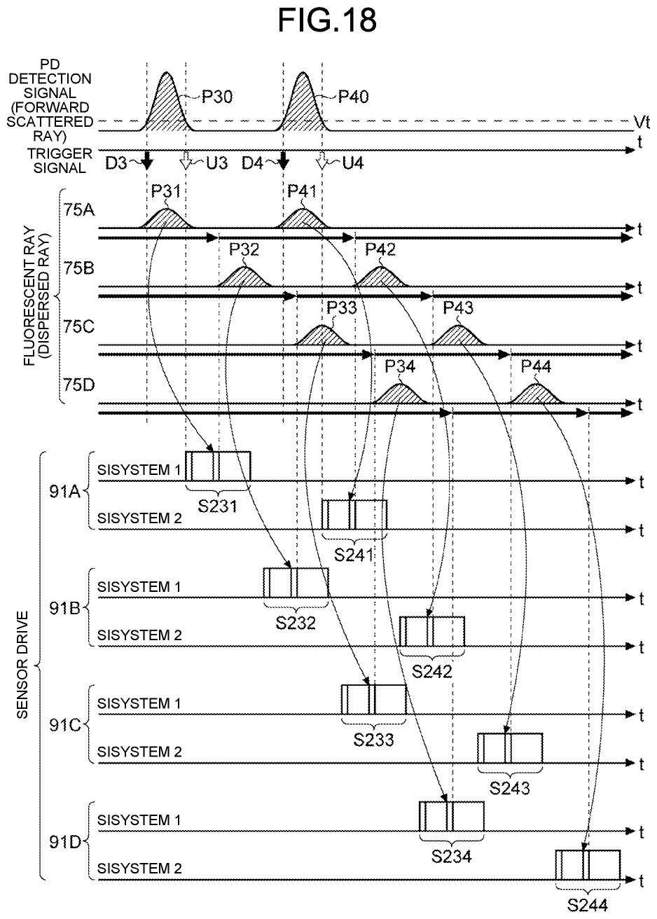

FIG. 18 is a timing chart illustrating an example of a schematic operation of a multispot type flow cytometer according to the second embodiment. Note that FIG. 18 extracts an operation corresponding to the operation described using the PD detection signals P30 and P40 and the pulses P31 to P34 and P41 to P44 in FIG. 13 in the first embodiment.

As described above, in the second embodiment, two systems of readout configurations are connected to one pixel 201. Therefore, in the present embodiment, as illustrated in FIG. 18, in the regions 91A to 91D, readout operations S231 to S234 are executed in one readout configuration (for example, a configuration including the constant current circuit 122a, the vertical signal line 124a, and the detection circuit 93a, represented by system 1 in FIG. 18), respectively, and then readout operations S241 to S244 are executed in the other readout configuration (for example, a configuration including the constant current circuit 122b, the vertical signal line 124b, and the detection circuit 93b, represented by system 2 in FIG. 18), respectively.

2.4 Action and Effect

As described above, by executing a readout operation using the two systems of readout configurations alternately, for example, as indicated by the thick solid arrow in FIG. 18, a next accumulation period can be started at a time point when charges accumulated in the accumulation node 112 are transferred to a floating diffusion 117. As a result, for example, even when a plurality of specimens 53 passes through the irradiation spot 72A in a short time as in the PD detection signals P30 and P40 illustrated in FIG. 13, it is possible to largely reduce incidence of the pulses P31 to P34 and P41 to P44 of the specimens 53 on the respective regions 91A to 91D within the same accumulation period. As a result, detection errors due to multiple exposure are reduced, and therefore detection omissions can be significantly reduced.

Other configurations, operations, and effects may be similar to those of the above-described embodiment or modifications thereof, and therefore detailed description thereof is omitted here.

### 3. Third Embodiment

Next, a flow cytometer as an optical measuring device and an optical measuring system according to a third embodiment will be described in detail with reference to the drawings. Note that, in the following description, the same reference numerals are given to similar configurations and operations to those of the above-described embodiment or modifications thereof, and redundant description thereof will be omitted.

In the above embodiment, the configuration in which a trigger signal is generated using the forward scattered ray 73 (alternatively, a side scattered ray, a back scattered ray, a back scattered ray, or the like) of the excitation ray 71 or 71A output from the excitation light source 32 or 32A is exemplified, but the present disclosure is not limited to such a configuration. For example, by disposing a light source intended to generate a trigger signal (hereinafter, referred to as a trigger light source) on an upstream side of a sample flow 52 with respect to the excitation light source 32 or 32A to 32D, a trigger signal can be generated using a forward scattered ray (alternatively, a side scattered ray, a back scattered ray, or the like) of laser light output from the trigger light source (hereinafter, referred to as trigger light).

3.1 Example of Schematic Configuration of Flow Cytometer

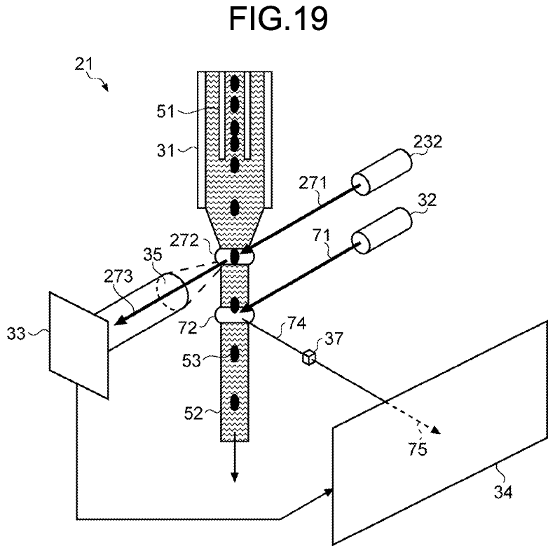

FIG. 19 is a schematic diagram illustrating an example of a schematic configuration of the flow cytometer according to the third embodiment. Note that, in the present embodiment, a single spot type flow cytometer 21 is exemplified. In addition, in FIG. 19, the condenser lens 36 is omitted, and the spectroscopic optical system 37 and the dispersed ray 75 are simplified for simplification of description.

As illustrated in FIG. 19, the flow cytometer 21 has a configuration in which a trigger light source 232 that irradiates an irradiation spot 272 located upstream of the irradiation spot 72 in the sample flow 52 with a trigger light 271 is disposed in a configuration similar to that of the single spot type flow cytometer 1 described with reference to FIG. 1 in the first embodiment. In addition, in the present embodiment, a condenser lens 35 condenses a forward scattered ray 273 of the trigger light 271 that has passed through the irradiation spot 272, and a photodiode 33 observes the forward scattered ray 273.

As the trigger light source 232, for example, various light sources such as a white light source and a monochromatic light source can be used.

Note that, in the image sensor 34 in the single spot type flow cytometer 21, for example, one detection circuit 93 may be disposed for one pixel 101. When such a configuration of one pixel and one ADC is implemented, it is possible to perform a so-called global shutter method readout operation in which a readout operation is executed simultaneously and in parallel for all the pixels 101 of a pixel array unit 91.

In the configuration implementing the global shutter method, for example, the selection transistor 115 can be omitted from the pixel circuit described with reference to FIG. 9 in the first embodiment. In this case, a drain of an amplification transistor 114 is connected to a vertical signal line 124 all the time, and all the pixels 101 are selected all the time.

However, the present disclosure is not limited to the global shutter method, and various readout operations and configurations such as a so-called rolling shutter method readout operation and a configuration therefor can be adopted.

3.2 Example of Schematic Operation of Flow Cytometer

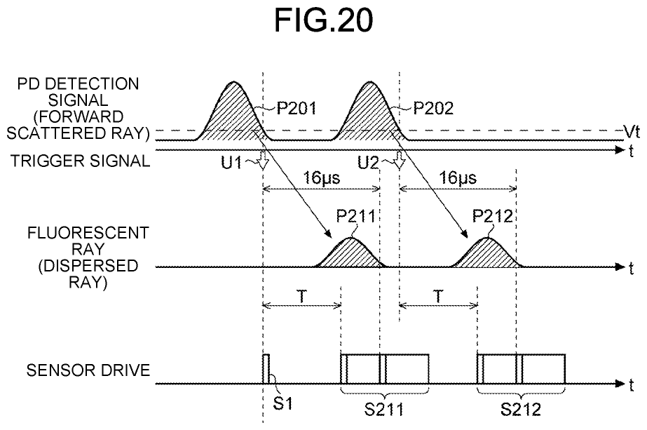

FIG. 20 is a timing chart illustrating an example of a schematic operation of the flow cytometer according to the third embodiment. Note that FIG. 20 illustrates a case where two specimens 53 continuously pass through irradiation spots 272 and 72. In addition, in the present description, a time interval at which the same specimen 53 sequentially passes through the irradiation spots 272 and 72 is 16 μs.

As illustrated in FIG. 20, in the present embodiment, for example, the photodiode 33 generates off-edge trigger signals U1 and U2 of PD detection signals P201 and P202, respectively, and inputs the generated off-edge trigger signals U1 and U2 to the image sensor 34 as needed.

First, when the off-edge trigger signal U1 due to passage of the first specimen 53 of the two specimens 53 is input to the image sensor 34 from the photodiode 33, the image sensor 34 supplies a reset signal S1 to all the pixels 101 of the pixel array unit 91, thereby performing PD reset on all the pixels 101.

Subsequently, the image sensor 34 executes a readout operation S211 for all the pixels 101 after a lapse of a predetermined time T from input of the off-edge trigger signal U1 to the image sensor 34. As a result, a spectral image of a fluorescent ray 74 emitted from the first specimen 53 is output from the image sensor 34.

Here, as the predetermined time T, for example, various times such as a time required for matching a timing when charges accumulated in an accumulation node 112 are transferred to a floating diffusion 117 with a timing when the pulse P211 of the dispersed ray 75 finishes being incident on the image sensor 34 can be adopted. The predetermined time T is determined in advance by, for example, an actual measurement value, simulation, or the like, and may be set in the pixel drive circuit 94, the logic circuit 95, or the like.

Next, when the off-edge trigger signal U2 due to passage of the second specimen 53 is input from the photodiode 33 to the image sensor 34, the image sensor 34 executes a readout operation S212 for all the pixels 101 after a lapse of the predetermined time T from input of the off-edge trigger signal U1 to the image sensor 34. As a result, a spectral image of the fluorescent ray 74 emitted from the second specimen 53 is output from the image sensor 34.

Note that, in a case where the readout operation S211 for the first specimen 53 is completed when the off-edge trigger signal U2 due to passage of the second specimen 53 is input to the image sensor 34, the image sensor 34 may perform PD reset on all the pixels 101 in accordance with the off-edge trigger signal U2.

3.3 Action and Effect

As described above, in the present embodiment, the off-edge trigger signal is generated not using the forward scattered ray 73 of the excitation ray 71 but using the forward scattered ray 273 of the trigger light 271 output from the trigger light source 232 disposed exclusively for triggering. As a result, a timing when the readout operation is started can be freely set with respect to passage of the specimen 53. Therefore, readout of a spectral image from the image sensor 34 can be started at a more accurate timing.

Other configurations, operations, and effects may be similar to those of the above-described embodiment or modifications thereof, and therefore detailed description thereof is omitted here.

3.4 Modification 1

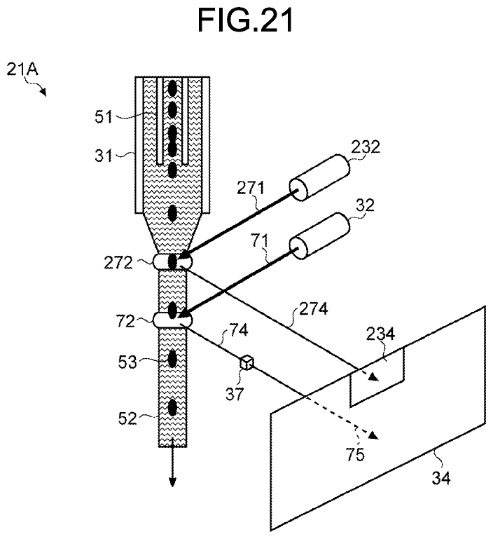

FIG. 21 is a schematic diagram illustrating an example of a schematic configuration of a flow cytometer according to Modification 1 of the third embodiment. As illustrated in FIG. 21, a flow cytometer 21A according to the present modification has a configuration in which the photodiode 33 is omitted, and a photodiode region 234 is formed in a part (upstream side) of the image sensor 34 instead of the photodiode 33 in a configuration similar to the flow cytometer 21 illustrated in FIG. 19.

The photodiode region 234 may be, for example, a photodiode built in a specific region in the same chip as the image sensor 34. In this case, the photodiode region 234 is located at a position deviated from a straight line connecting the trigger light source 232 and the irradiation spot 272.

When the specimen 53 passes through the irradiation spot 272, a side scattered ray 274 of the trigger light 271 is incident on the photodiode region 234 through the condenser lens 35 (not illustrated). The photodiode region 234 generates a trigger signal (on-edge trigger signal and/or off-edge trigger signal) on the basis of a PD detection signal of the incident side scattered ray 274, and inputs the generated trigger signal to the image sensor 34.

As described above, a trigger signal can also be generated using the side scattered ray 274 instead of the forward scattered ray 73 of the trigger light 271. Note that the photodiode 33 can be used instead of the photodiode region 234.

3.5 Modification 2

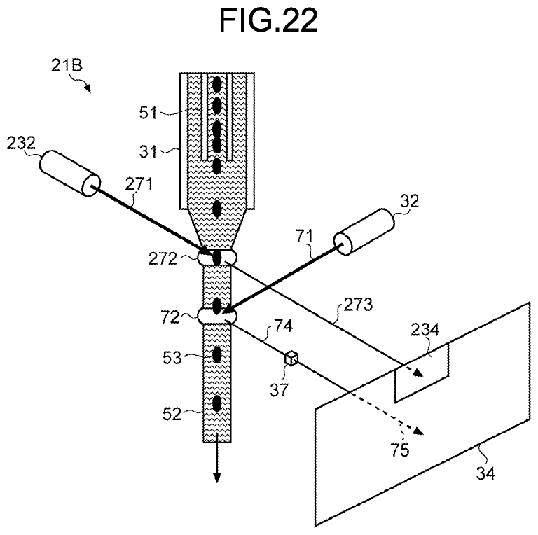

FIG. 22 is a schematic diagram illustrating an example of a schematic configuration of a flow cytometer according to Modification 2 of the third embodiment. As illustrated in FIG. 21, a flow cytometer 21B according to the present modification has a configuration in which the trigger light source 232 is disposed on a straight line connecting the photodiode region 234 (for example, the center of a light receiving surface thereof) and the irradiation spot 272 (for example, the center thereof) on a side opposite to the photodiode region 234 across the irradiation spot 272 in a configuration similar to the flow cytometer 21A illustrated in FIG. 21. In this case, a straight line connecting the trigger light source 232 and the irradiation spot 272 has a twisted positional relationship with a straight line connecting the excitation light source 32A and the irradiation spot 72A.

In such a configuration, the forward scattered ray 273 of the trigger light 271 is incident on the photodiode region 234. Therefore, the photodiode region 234 generates a trigger signal (on-edge trigger signal and/or off-edge trigger signal) on the basis of a PD detection signal of the incident side forward scattered ray 273, and inputs the generated trigger signal to the image sensor 34.

As described above, the trigger light source 232 may be disposed on ae straight line connecting the photodiode region 234 and the irradiation spot 272 on a side opposite to the photodiode region 234 across the irradiation spot 272.

3.6 Modification 3

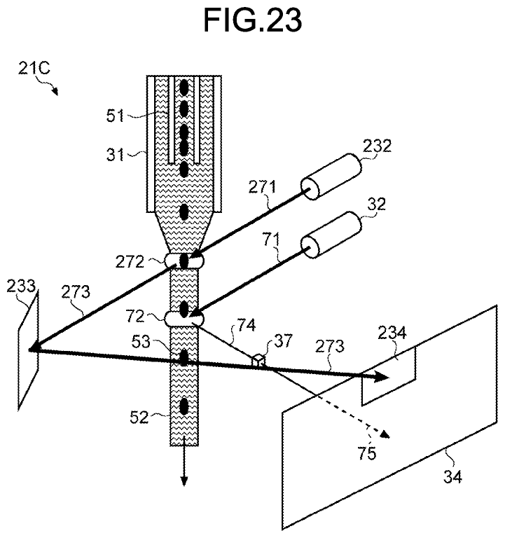

FIG. 23 is a schematic diagram illustrating an example of a schematic configuration of a flow cytometer according to Modification 3 of the third embodiment. As illustrated in FIG. 23, a flow cytometer 21C according to the present modification further includes a mirror 233 that reflects the forward scattered ray 273 that has passed through the irradiation spot 272 toward the photodiode region 234 formed in the image sensor 34 in addition to a configuration similar to that of the flow cytometer 21A illustrated in FIG. 21.

Also with such a configuration, a trigger signal can be generated using the forward scattered ray 73 of the trigger light 271.

Note that the above-described Modifications 1 to 3 can be applied not only to the third embodiment, but also similarly to the above-described or later-described embodiments or modifications thereof. However, when Modifications 1 to 3 are applied to the first or second embodiment or modifications thereof, instead of the trigger light source 232 and the irradiation spot 272, the excitation light source 32 or 32A and the irradiation spot 72 or 72A are application targets.

### 4. Fourth Embodiment

Next, a flow cytometer as an optical measuring device and an optical measuring system according to a fourth embodiment will be described in detail with reference to the drawings. Note that, in the following description, the same reference numerals are given to similar configurations and operations to those of the above-described embodiment or modifications thereof, and redundant description thereof will be omitted.

In the fourth embodiment, a case where the single spot type flow cytometer 21 exemplified in the third embodiment is applied to a multispot type flow cytometer will be described with an example.

4.1 Example of Schematic Configuration of Flow Cytometer

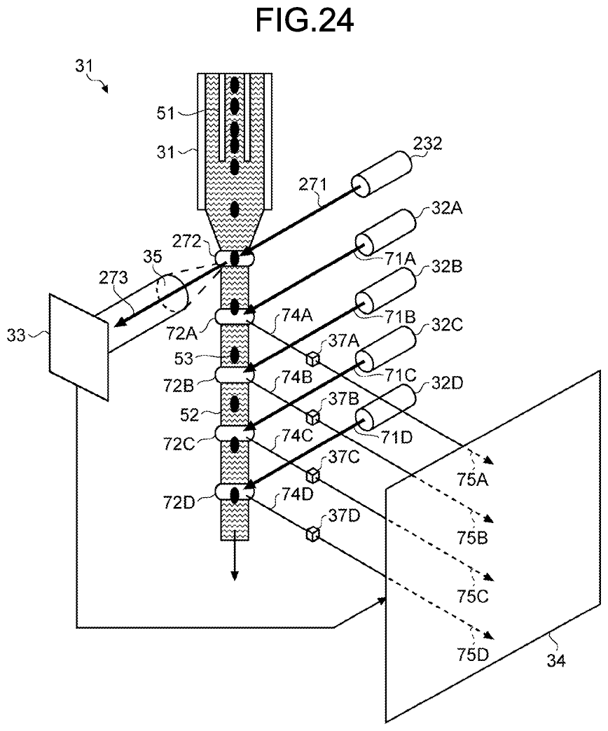

FIG. 24 is a schematic diagram illustrating an example of a schematic configuration of a flow cytometer according to the fourth embodiment. Note that, in FIG. 24, the condenser lens 36 that collimates fluorescent rays 74A to 74D emitted from irradiation spots 72A to 72D, respectively, is omitted, and spectroscopic optical systems 37A to 37D that spectrally disperse collimated fluorescent rays 74A to 74D, respectively, and dispersed rays 75A to 75D spectrally dispersed by the spectroscopic optical systems 37A to 37D, respectively, are simplified.

As illustrated in FIG. 24, a flow cytometer 31 according to the fourth embodiment has a configuration in which a trigger light source 232 that irradiates an irradiation spot 272 located upstream of the irradiation spot 72A in a sample flow 52 with trigger light 271 is disposed in a similar manner to the flow cytometer 21 according to the third embodiment, for example, in a configuration similar to that of the flow cytometer 11 described with reference to FIG. 3 in the first embodiment. In addition, in the present embodiment, in a similar manner to the third embodiment, a condenser lens 35 condenses a forward scattered ray 273 of the trigger light 271 that has passed through the irradiation spot 272, and a photodiode 33 observes the forward scattered ray 273.

4.2 Example of Schematic Operation of Flow Cytometer

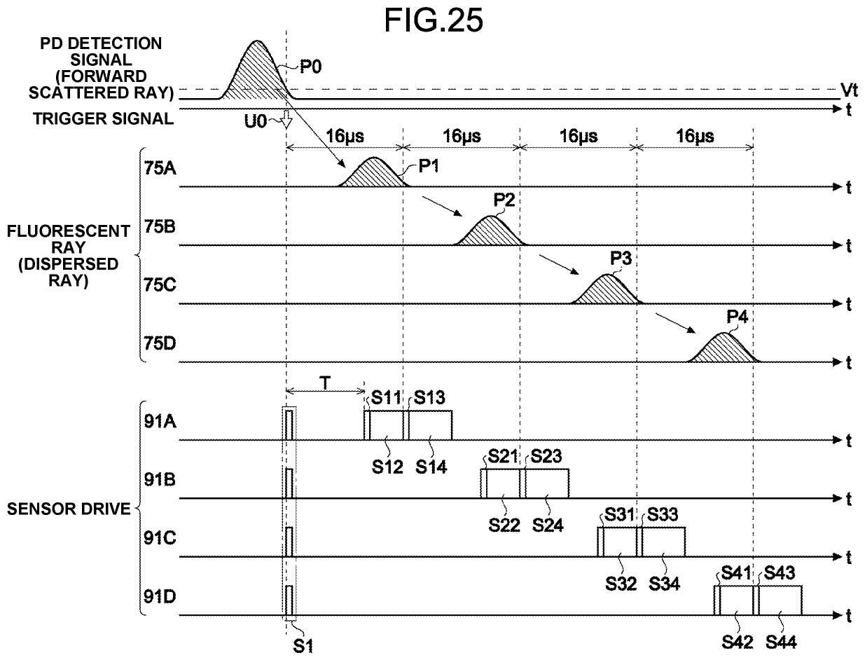

FIG. 25 is a timing chart illustrating an example of a schematic operation of the flow cytometer according to the fourth embodiment. Note that a case where the irradiation spots 272 and 72A to 72D are arranged at equal intervals along the sample flow 52, and a time interval until the specimen 53 that has passed through an irradiation spot on an upstream side passes through a next irradiation spot is 16 μs is exemplified.

As illustrated in FIG. 25, in a schematic operation of the flow cytometer 31 according to the fourth embodiment, for example, in a flow similar to the schematic operation of the flow cytometer 11 described with reference to FIG. 12 in the first embodiment, a periodic output of a reset signal S1 is replaced with output of the reset signal S1 when an off-edge trigger signal U0 is input, and a series of readout operations (S11 to S14) for a region 91A is started after a lapse of a predetermined time T from input of an off-edge trigger signal U.

Then, a series of readout operations (S21 to S24, S31 to S34, and S41 to S44) for the regions 91B to 91D is started with a time difference of 16 μs from start of a readout operation for the respective upstream regions thereof.

4.3 Relief Method when a Plurality of Specimens Passes During the Same Accumulation Period

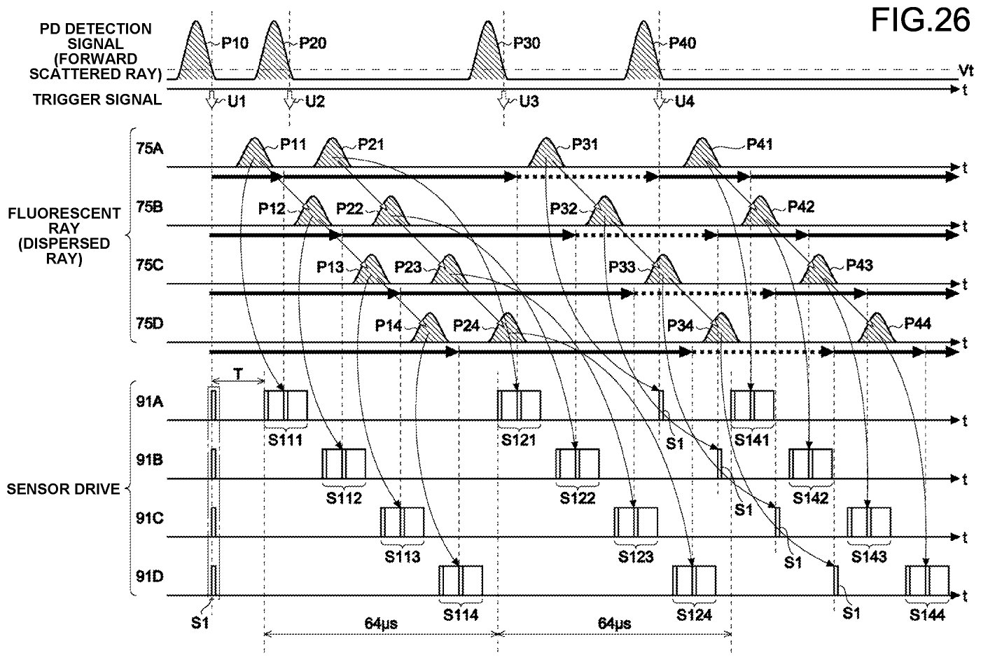

FIG. 26 is a timing chart for explaining an example of an operation according to the fourth embodiment. Note that, in the present description, a case where the present embodiment is applied to a case where the readout described with reference to FIG. 13 in the first embodiment fails will be described.

When the plurality of specimens 53 passes through the irradiation spot 272 in a short period of time as illustrated in the PD detection signals P30 and P40 of FIG. 13, whether or not the plurality of pulses P31 and P41 is incident on the same region 91A during the same accumulation period can be determined on the basis of, for example, an off-edge trigger signal U4 generated from a PD detection signal P40 that has detected the specimen 53 coming later.

For example, in a case where charges accumulated in the accumulation node 112 by photoelectric conversion of the pulse P31 are not transferred to the floating diffusion 117 when the off-edge trigger signal U4 is input, it can be determined that there is a high possibility that the pulses P31 and P41 are incident on the region 91A during the same accumulation period and readout fails.

When it is determined that the possibility of failure is high, in the present embodiment, a reset signal S1 is supplied to each pixel 101 in the region 91A in accordance with input of the off-edge trigger signal U4 used to determine the possibility of failure. As a result, charges of the pulse P31 accumulated in the accumulation node 112 can be released, and charges of the newly incident pulse P41 can be accumulated in the accumulation node 112. As a result, a spectral image of the pulse P41 can be relieved.

In addition, similarly, in the regions 91B to 91D, the reset signal S1 is input to the pixel 101 in each of the regions 91B to 91D at intervals of 16 μs from input of the off-edge trigger signal U4 used to determine that the possibility of failure is high, and PD reset is executed. As a result, spectral images of the pulses P42 to P44 can be relieved

4.4 Action and Effect

As described above, according to the present embodiment, when readout failure due to multiple exposure occurs, an exposure period is interrupted, and a next exposure period is started. As a result, it is possible to normally acquire a spectral image while avoiding multiple exposure, and therefore it is possible to reduce detection omission.

Other configurations, operations, and effects may be similar to those of the above-described embodiments and modifications thereof, and therefore detailed description thereof is omitted here.

### 5. Fifth Embodiment

Next, a flow cytometer as an optical measuring device and an optical measuring system according to a fifth embodiment will be described in detail with reference to the drawings. Note that, in the following description, the same reference numerals are given to similar configurations and operations to those of the above-described embodiment or modifications thereof, and redundant description thereof will be omitted.

In the fifth embodiment, a configuration of the image sensor 34 in the flow cytometers according to the above-described embodiments will be described with some examples.

5.1 Example of Chip Configuration

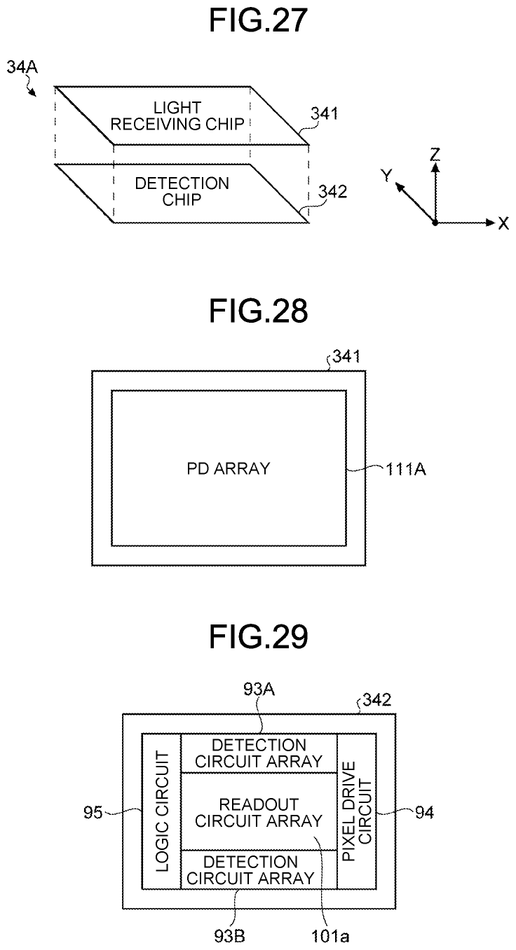

FIG. 27 is a diagram illustrating an example of a chip configuration of an image sensor according to the fifth embodiment. FIG. 28 is a plan view illustrating an example of a planar layout of a light receiving chip in FIG. 27. FIG. 29 is a plan view illustrating an example of a planar layout of a detection chip in FIG. 27.

As illustrated in FIG. 27, an image sensor 34A according to the fifth embodiment has, for example, a stack structure in which a light receiving chip (also referred to as a sensor die) 341 and a detection chip (also referred to as a logic die) 342 are bonded to each other vertically.

As illustrated in FIG. 28, the light receiving chip 341 is, for example, a semiconductor chip including a photodiode array 111A in which photodiodes 111 in pixels 101 are arrayed in a matrix.

Meanwhile, as illustrated in FIG. 29, the detection chip 342 is, for example, a semiconductor chip including a readout circuit array 101a in which readout circuits that are circuit elements other than the photodiodes 111 in the pixels 101 are arrayed in a matrix, detection circuit arrays 93A and 93B that are peripheral circuits, a pixel drive circuit 94, a logic circuit 95, and the like.

The photodiode array 111A in the light receiving chip 341 is disposed, for example, at the center of a light incident surface of the light receiving chip 341.

The readout circuit array 101a in the detection chip 342 is disposed, for example, on a bonding surface of the detection chip 342 with the light receiving chip 341 at a position corresponding to the photodiode array 111A of the light receiving chip 341.

The detection circuit arrays 93A and 93B are disposed, for example, in regions sandwiching the readout circuit array 101a from the column direction. In addition, the pixel drive circuit 94 and the logic circuit 95 are disposed, for example, in regions sandwiching the readout circuit array 101a from the row direction.

5.2 Example of Laminated Structure

For bonding the light receiving chip 341 and the detection chip 342 to each other, for example, so-called direct bonding can be used in which bonding surfaces of the light receiving chip 341 and the detection chip 342 are flattened and bonded to each other by an electronic force. However, the present disclosure is not limited thereto, and for example, so-called Cu—Cu bonding in which copper (Cu) electrode pads formed on the bonding surfaces of the light receiving chip 341 and the detection chip 342 are bonded to each other, bump bonding, or the like can also be used.

In addition, the light receiving chip 341 and the detection chip 342 are electrically connected to each other, for example, via a connection unit such as a through-silicon via (TSV) penetrating a semiconductor substrate. For the connection using a TSV, for example, a so-called twin TSV method in which two TSVs, that is, a TSV formed in the light receiving chip 341 and a TSV formed from the light receiving chip 341 to the detection chip 342 are connected to each other on an outer surface of the chips, a so-called shared TSV method in which the light receiving chip 341 and the detection chip 342 are connected to each other by a TSV penetrating a portion extending from the light receiving chip 341 to the detection chip 342, or the like can be adopted.

However, when Cu—Cu bonding or bump bonding is used for bonding the light receiving chip 341 and the detection chip 342 to each other, the light receiving chip 341 and the detection chip 342 are electrically connected to each other via a Cu—Cu bonding portion or a bump bonding portion.

5.2.1 Example of First Laminated Structure

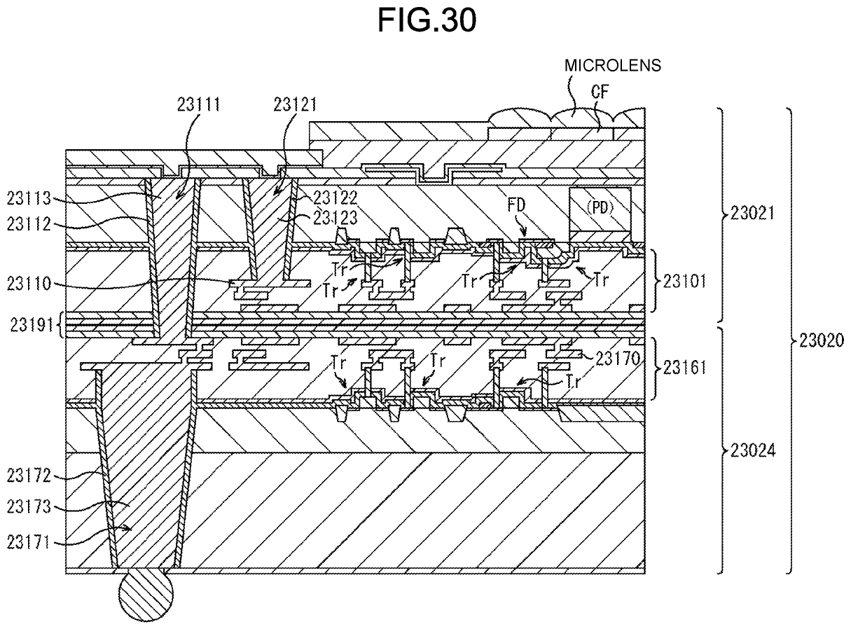

FIG. 30 is a cross-sectional view illustrating an example of a first laminated structure. As illustrated in FIG. 30, in the example of the first laminated structure, in a sensor die 23021 of an image sensor 23020, a photodiode PD constituting the pixels 101 serving as a pixel region 23012 (corresponding to a pixel array unit 91), a floating diffusion FD, various transistors Tr constituting a readout circuit and the like, various transistors Tr serving as control circuits 23013 (corresponding to the pixel drive circuit 94), and the like are formed. Furthermore, in the sensor die 23021, a wiring layer 23101 having a plurality of layers of wiring lines 23110, in this example, three layers of wiring lines 23110, is formed. Note that (the transistor Tr serving as) the control circuit 23013 can be constituted not in the sensor die 23021 but in the logic die 23024.

In the logic die 23024, various transistors Tr constituting the logic circuit 23014 (corresponding to the logic circuit 95) are formed. Furthermore, in the logic die 23024, a wiring layer 23161 having a plurality of layers of wiring lines 23170, in this example, three layers of wiring lines 23170, is formed. In addition, in the logic die 23024, a connection hole 23171 having an insulating film 23172 on an inner wall surface thereof is formed, and a connection conductor 23173 to be connected to the wiring line 23170 and the like is embedded in the connection hole 23171.

The sensor die 23021 and the logic die 23024 are bonded to each other such that the wiring layers thereof 23101 and 23161 face each other, thereby constituting a laminated image sensor 23020 in which the sensor die 23021 and the logic die 23024 are laminated. A film 23191 such as a protective film is formed on a surface on which the sensor die 23021 and the logic die 23024 are bonded to each other.

In the sensor die 23021, a connection hole 23111 penetrating the sensor die 23021 from a back surface side (side on which light is incident on the photodiode PD) (upper side) of the sensor die 23021 and reaching the wiring line 23170 of an uppermost layer of the logic die 23024 is formed. Furthermore, in the sensor die 23021, a connection hole 23121 reaching the wiring line 23110 of a first layer from a back surface side of the sensor die 23021 is formed in proximity to the connection hole 23111. An insulating film 23112 is formed on an inner wall surface of the connection hole 23111, and an insulating film 23122 is formed on an inner wall surface of the connection hole 23121. Then, connection conductors 23113 and 23123 are embedded in the connection holes 23111 and 23121, respectively. The connection conductors 23113 and 23123 are electrically connected to each other on a back surface side of the sensor die 23021, and the sensor die 23021 and the logic die 23024 are thereby electrically connected to each other via the wiring layer 23101, the connection hole 23121, the connection hole 23111, and the wiring layer 23161.

5.2.2 Example of Second Laminated Structure

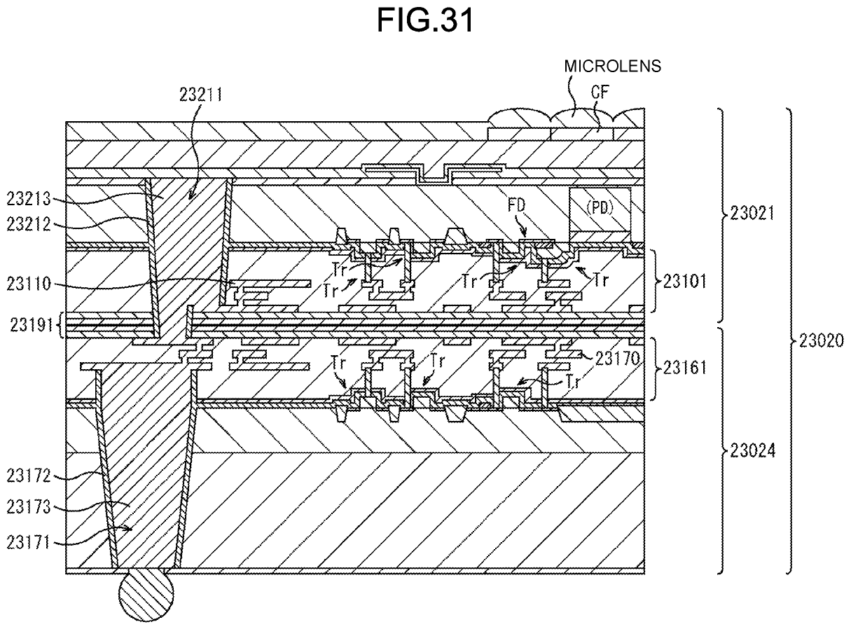

FIG. 31 is a cross-sectional view illustrating an example of a second laminated structure. As illustrated in FIG. 31, in the example of the second laminated structure, ((the wiring line 23110 of) the wiring layer 23101 of) the sensor die 23021 and ((the wiring line 23170 of) the wiring layer 23161 of) the logic die 23024 are electrically connected to each other by one connection hole 23211 formed in the sensor die 23021 of the image sensor 23020.

That is, in FIG. 31, the connection hole 23211 is formed so as to penetrate the sensor die 23021 from a back surface side of the sensor die 23021, to reach the wiring line 23170 of an uppermost layer of the logic die 23024, and to reach the wiring line 23110 of an uppermost layer of the sensor die 23021. An insulating film 23212 is formed on an inner wall surface of the connection hole 23211, and a connection conductor 23213 is embedded in the connection hole 23211. In FIG. 30 described above, the sensor die 23021 and the logic die 23024 are electrically connected to each other by the two connection holes 23111 and 23121. However, in FIG. 31, the sensor die 23021 and the logic die 23024 are electrically connected to each other by one connection hole 23211.

5.2.3 Example of Third Laminated Structure

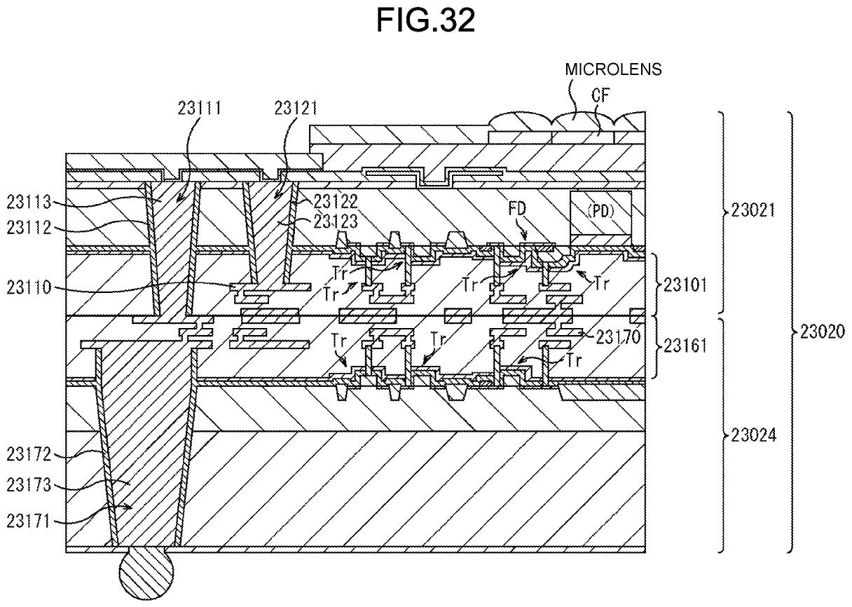

FIG. 32 is a cross-sectional view illustrating an example of a third laminated structure. As illustrated in FIG. 32, the example of the third laminated structure is different from the case of FIG. 30 in which the film 23191 such as a protective film is formed on a surface where the sensor die 23021 and the logic die 23024 are bonded to each other in that the film 23191 such as a protective film is not formed on the surface where the sensor die 23021 and the logic die 23024 are bonded to each other.

The image sensor 23020 in FIG. 32 is constituted by overlapping the sensor die 23021 and the logic die 23024 with each other such that the wiring lines 23110 and 23170 are in direct contact with each other, and heating the sensor die 23021 and the logic die 23024 while applying a required weight thereto to directly bond the wiring lines 23110 and 23170 to each other.

5.2.4 Example of Fourth Laminated Structure

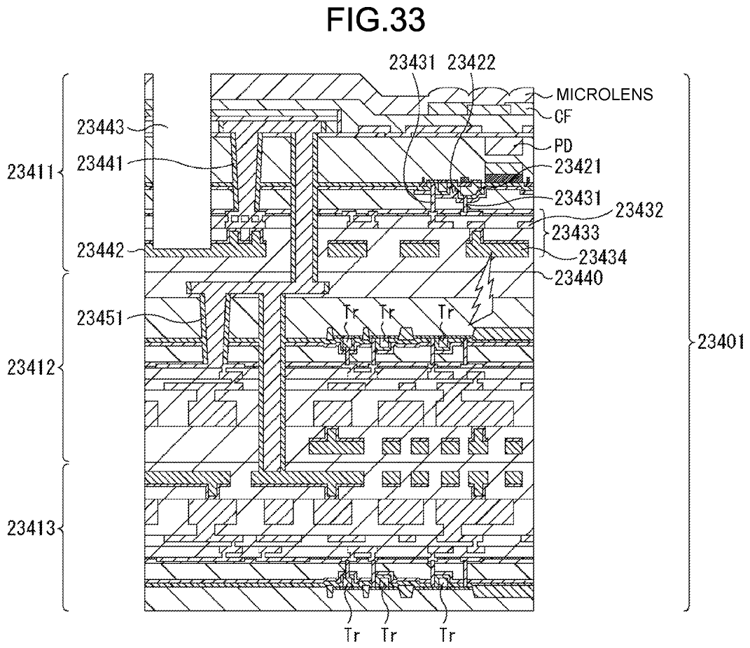

FIG. 33 is a cross-sectional view illustrating an example of a fourth laminated structure. As illustrated in FIG. 33, in the example of the fourth laminated structure, an image sensor 23401 has a three-layer laminated structure in which three dies of a sensor die 23411, a logic die 23412, and a memory die 23413 are laminated.

The memory die 23413 includes, for example, a memory circuit that stores data temporarily required in signal processing performed in the logic die 23412.

In FIG. 33, the logic die 23412 and the memory die 23413 are laminated in this order under the sensor die 23411, but the logic die 23412 and the memory die 23413 can be laminated under the sensor die 23411 in the reverse order, that is, in the order of the memory die 23413 and the logic die 23412.

Note that, in FIG. 33, a photodiode PD serving as a photoelectric conversion unit of a pixel and source/drain regions of various transistors (hereinafter, referred to as pixel transistors) Tr constituting a readout circuit and the like are formed in the sensor die 23411.

A gate electrode is formed around the photodiode PD via a gate insulating film, and each of pixel transistors 23421 and 23422 is formed by a gate electrode and a source/drain region forming a pair.

The pixel transistor 23421 adjacent to the photodiode PD is a transfer transistor 113, and one of a source region and a drain region forming a pair and constituting the pixel transistor 23421 is a floating diffusion 117.

In addition, an interlayer insulating film is formed in the sensor die 23411, and a connection hole is formed in the interlayer insulating film. In the connection hole, a connection conductor 23431 connected to the pixel transistors 23421 and 23422 is formed.

Furthermore, in the sensor die 23411, a wiring layer 23433 having a plurality of layers of a wiring line 23432 connected to each connection conductors 23431 is formed.

In addition, an aluminum pad 23434 serving as an electrode for external connection is formed in a lowermost layer of the wiring layer 23433 of the sensor die 23411. That is, in the sensor die 23411, the aluminum pad 23434 is formed at a position closer to a bonding surface 23440 with the logic die 23412 than the wiring line 23432. The aluminum pad 23434 is used as one end of a wiring line relating to input and output of a signal to and from the outside.

Furthermore, in the sensor die 23411, a contact 23441 used for electrical connection with the logic die 23412 is formed. The contact 23441 is connected to a contact 23451 of the logic die 23412, and is also connected to the aluminum pad 23442 of the sensor die 23411.

In addition, in the sensor die 23411, a pad hole 23443 is formed so as to reach the aluminum pad 23442 from a back surface side (upper side) of the sensor die 23411.

5.2.5 Example of Fifth Laminated Structure

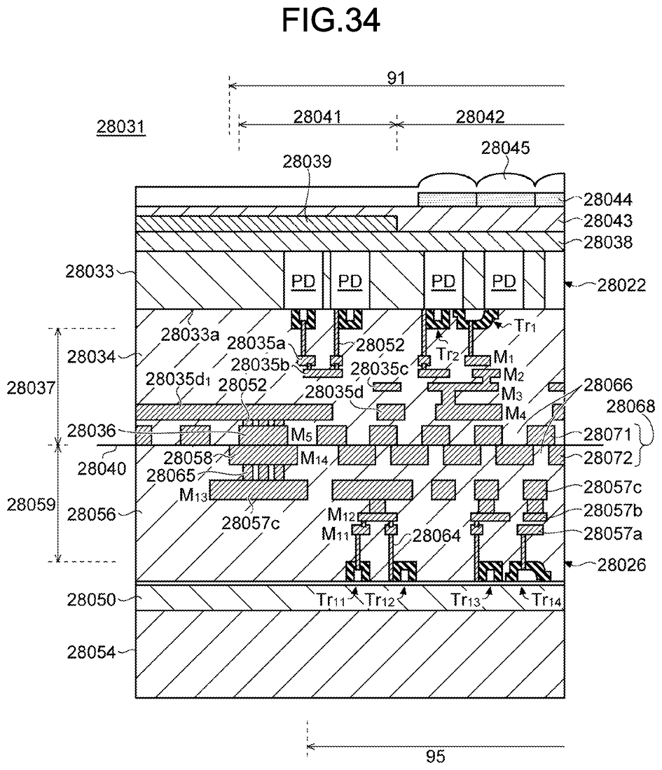

FIG. 34 is a cross-sectional view illustrating an example of a fifth laminated structure. As illustrated in FIG. 34, the example of the fifth laminated structure includes a laminated semiconductor chip 28031 in which a first semiconductor chip portion 28022 including the pixel array unit 91 and the pixel drive circuit 94, and a second semiconductor chip portion 28026 including the logic circuit 95 are bonded to each other. The first semiconductor chip portion 28022 and the second semiconductor chip portion 28026 are bonded to each other such that multilayer wiring layers of the first semiconductor chip portion 28022 and the second semiconductor chip portion 28026 described later face each other and connection wiring lines thereof are directly bonded to each other.

In the first semiconductor chip portion 28022, the pixel array unit 91 in which a plurality of pixels including a photodiode PD serving as a photoelectric conversion unit and a plurality of pixel transistors Tr₁ and Tr₂ is two-dimensionally arrayed in a column shape is formed in a first semiconductor substrate 28033 made of thinned silicon. In addition, although not illustrated, a plurality of MOS transistors constituting the pixel drive circuit 94 is formed in the first semiconductor substrate 28033. On a front surface 28033a side of the first semiconductor substrate 28033, a multilayer wiring layer 28037 having a plurality of layers of, in this example, five layers of wiring lines 28035 (28035a to 28035d) and 28036 made of metals M₁ to M₅ is formed via an interlayer insulating film 28034. As the wiring lines 28035 and 28036, a copper (Cu) wiring line formed by a dual damascene method is used. On a back surface side of the first semiconductor substrate 28033, a light shielding film 28039 is formed via an insulating film 28038 so as to include an upper portion of an optical black region 28041, and a color filter 28044 and an on-chip lens 28045 are further formed on an effective pixel region 28042 via a flattening film 28043. The on-chip lens 28045 can also be formed on the optical black region 28041.

In FIG. 34, the pixel transistors Tr₁ and Tr₂ represent a plurality of pixel transistors. In the first semiconductor chip portion 28022, the photodiode PD is formed in the thinned first semiconductor substrate 28033. The photodiode PD is formed so as to have, for example, an n-type semiconductor region and a p-type semiconductor region on a substrate surface side. A gate electrode is formed on a surface of the substrate constituting a pixel via a gate insulating film, and the pixel transistors Tr₁ and Tr₂ are formed by the gate electrode and a source/drain region forming a pair. The pixel transistor Tr₁ adjacent to the photodiode PD corresponds to the floating diffusion FD. Each unit pixel is isolated by an element isolation region. The element isolation region is formed, for example, so as to have a shallow trench isolation (STI) structure in which an insulating film such as a SiO₂ film is embedded in a groove formed in a substrate.

In the multilayer wiring layer 28037 of the first semiconductor chip portion 28022, the wiring line 28035 is connected to a pixel transistor corresponding thereto via a conductive via 28052, and the wiring lines 28035 in adjacent upper and lower layers are connected to each other via the conductive via 28052. Furthermore, a wiring line 28036 made of a metal M₅ of a fifth layer is formed facing a bonding surface 28040 with the second semiconductor chip portion 28026. The wiring line 28036 is connected to a required wiring line 28035d of a metal M₄ of a fourth layer via the conductive via 28052.

In the second semiconductor chip portion 28026, the logic circuit 95 constituting a peripheral circuit is formed in a region serving as each chip portion of a second semiconductor substrate 28050 made of silicon. The logic circuit 95 includes a plurality of MOS transistors Tr₁₁ and Tr₁₄ including a CMOS transistor. On a front surface side of the second semiconductor substrate 28050, a multilayer wiring layer 28059 having a plurality of layers of, in this example, four layers of wiring lines 28057 (28057a to 28057c) and 28058 made of metals M₁₁ to M₁₄ is formed via an interlayer insulating film 28056. As the wiring lines 28057 and 28058, a copper (Cu) wiring line formed by a dual damascene method is used.

In FIG. 34, a plurality of MOS transistors of the logic circuit 95 is represented by MOS transistors Tr₁₁ and Tr₁₄. In the second semiconductor chip portion 28026, each of the MOS transistors Tr₁₁ and Tr₁₂ is formed in a semiconductor well region on a front surface side of the second semiconductor substrate 28050 so as to have a source/drain region forming a pair and a gate electrode with a gate insulating film therebetween. Each of the MOS transistors Tr₁₁ and Tr₁₂ is isolated by, for example, an element isolation region having an STI structure. Note that a support substrate 28054 or the like may be bonded to a back surface side of the second semiconductor substrate 28050.

In the multilayer wiring layer 28059 of the second semiconductor chip portion 28026, the MOS transistors Tr₁₁ and Tr₁₄ are connected to the wiring line 28057 via a conductive via 28064, and the wiring lines 28057 in adjacent upper and lower layers are connected to each other via the conductive via 28064. Furthermore, a wiring line 28058 made of a metal M₁₄ of a fourth layer is formed facing the bonding surface 28040 with the first semiconductor chip portion 28022. The wiring line 28058 is connected to a required wiring line 28057c by a metal M₁₃ of a third layer via a conductive via 28065.

The first semiconductor chip portion 28022 and the second semiconductor chip portion 28026 are electrically connected to each other by directly bonding the wiring lines 28036 and 28058 facing the bonding surface 28040 to each other such that the multilayer wiring layer 28037 of the first semiconductor chip portion 28022 and the multilayer wiring layer 28059 of the second semiconductor chip portion 28026 face each other. An interlayer insulating film 28066 near bonding is formed by a combination of a Cu diffusion barrier insulating film for preventing Cu diffusion of a Cu wiring line and an insulating film having no Cu diffusion barrier property as described in a manufacturing method described later. The direct bonding of the wiring lines 28036 and 28058 by a Cu wiring line is performed by thermal diffusion bonding. The interlayer insulating films 28066 other than the wiring lines 28036 and 28058 are bonded to each other by plasma bonding or an adhesive.

Then, in the example of the fifth laminated structure, in particular, as illustrated in FIG. 34, a light shielding layer 28068 made of a conductive film in the same layer as a connection wiring line is formed in the vicinity of the bonding of the first and second semiconductor chip portions 28022 and 28026. The light shielding layer 28068 is formed by a light shielding portion 28071 made of a metal M₅ in the same layer as the wiring line 28036 on the first semiconductor chip portion 28022 side and a light shielding portion 28072 made of a metal M₁₄ in the same layer as the wiring line 28058 on the second semiconductor chip portion 28026 side. In this case, either one of the light shielding portions 28071 and 28072, in this example, the light shielding portion 28071 is formed in a shape having a plurality of openings at a predetermined vertical and horizontal pitch when viewed from above, and the other light shielding portion 28072 is formed in a dot shape that closes the openings of the light shielding portion 28071 when viewed from above. The light shielding layer 28068 is formed such that both the light shielding portions 28071 and 28072 overlap each other in a state of being uniformly closed when viewed from above.

The light shielding portion 28071 and the light shielding portion 28072 closing the openings of the light shielding portion 28071 are formed so as to partially overlap each other. When the wiring lines 28036 and 28058 are directly bonded to each other, the light shielding portion 28071 and the light shielding portion 28072 are directly bonded to each other at the same time at an overlapping portion. Various shapes are conceivable as the shape of the opening of the light shielding portion 28071, and for example, the opening is formed in a quadrangular shape. Meanwhile, the dot-shaped light shielding portion 28072 has a shape that closes the opening, and is formed in, for example, a rectangular shape having an area larger than the area of the opening. Preferably, a fixed potential, for example, a ground potential is applied to the light shielding layer 28068, and the light shielding layer 28068 is stabilized in terms of potential.

Although the embodiments of the present disclosure have been described above, the technical scope of the present disclosure is not limited to the above-described embodiments as they are, and various modifications can be made without departing from the gist of the present disclosure. In addition, components of different embodiments and modifications may be appropriately combined with each other.

In addition, the effects of the embodiments described here are merely examples and are not limited, and other effects may be provided.

Note that the present technology can also have the following configurations.

(1)

An optical measuring device comprising:

a plurality of excitation light sources that irradiates a plurality of positions on a flow path through which a specimen flows with excitation rays having different wavelengths; and

a solid-state imaging device that receives a plurality of fluorescent rays emitted from the specimen passing through each of the plurality of positions, wherein

the solid-state imaging device includes:

a pixel array unit in which a plurality of pixels is arrayed in a matrix; and

a plurality of first detection circuits connected to a plurality of pixels not adjacent to each other in the same column of the pixel array unit, respectively.

(2)

The optical measuring device according to (1), wherein the first detection circuits are connected to the plurality of pixels having the same number as the number of the plurality of excitation light sources, respectively.

(3)

The optical measuring device according to (1) or (2), wherein

the pixel array unit is divided into a plurality of regions arrayed in a column direction of the matrix, and

each of the first detection circuits is connected to one of the pixels in each of the plurality of regions.

(4)

The optical measuring device according to (3), further comprising an optical element that guides the plurality of fluorescent rays to different regions of the plurality of regions, respectively.

(5)

The optical measuring device according to (4), wherein the pixel array unit is divided into the plurality of regions having the same number as the number of the plurality of excitation light sources.

(6)

The optical measuring device according to (4) or (5), wherein the optical element includes a spectroscopic optical system that spectrally disperses each of the plurality of fluorescent rays.

(7)

The optical measuring device according to any one of (1) to (6), further comprising a control unit that controls readout of a pixel signal from the pixel array unit in accordance with passage of the specimen through each of the plurality of positions.

(8)

The optical measuring device according to (7), further comprising a detection unit that detects that the specimen has passed through a first position located on a most upstream side of the plurality of positions on the flow path, wherein

the control unit controls the readout on a basis of a detection result by the detection unit.

(9)

The optical measuring device according to (8), wherein

the plurality of excitation light sources includes a first excitation light source that irradiates the first position with a first excitation ray, and

the detection unit detects that the specimen has passed through the first position on a basis of light emitted from the first position.

(10)

The optical measuring device according to (9), wherein

the plurality of positions includes the first position, a second position located downstream of the first position on the flow path, and a third position located downstream of the second position on the flow path,

the plurality of excitation light sources includes the first excitation light source, a second excitation light source that irradiates the second position with a second excitation ray, and a third excitation light source that irradiates the third position with a third excitation ray,

the plurality of fluorescent rays includes a first fluorescent ray emitted from the specimen passing through the first position, a second fluorescent ray emitted from the specimen passing through the second position, and a third fluorescent ray emitted from the specimen passing through the third position,

the first fluorescent ray, the second fluorescent ray, and the third fluorescent ray are incident on different regions in the pixel array unit, and

the control unit controls the readout for each of the different regions.

(11)

The optical measuring device according to (10), wherein

the first position, the second position, and the third position are set at equal intervals along the flow path, and

the control unit starts first readout with respect to a first region on which the first fluorescent ray is incident in the pixel array unit when the detection unit detects that the specimen has passed through the first position, starts second readout with respect to a second region on which the second fluorescent ray is incident in the pixel array unit after a lapse of a predetermined time from start of the first readout, and starts third readout with respect to a third region on which the third fluorescent ray is incident in the pixel array unit after a lapse of the predetermined time from start of the second readout.

(12)

The optical measuring device according to (9), wherein the detection unit is a light receiving element disposed on a straight line including the first excitation light source and the first position on a side opposite to the first excitation light source across the first position.

(13)

The optical measuring device according to (9), wherein the detection unit is a light receiving element disposed at a position deviated from a straight line including the first excitation light source and the first position.

(14)

The optical measuring device according to (12) or (13), wherein the light receiving element is a light receiving element isolated from a semiconductor chip including the pixel array unit.

(15)

The optical measuring device according to (12) or (13), wherein the light receiving element is a light receiving element disposed in the same semiconductor chip as a semiconductor chip including the pixel array unit.

(16)

The optical measuring device according to (1), further comprising a plurality of second detection circuits corresponding to the first detection circuits on a one-to-one basis, respectively, and connected to the plurality of pixels to which the corresponding first detection circuits are connected.

(17)

The optical measuring device according to (16), further comprising a control unit that controls readout of a pixel signal from the pixel array unit such that the first detection circuit and the second detection circuit are alternately used.

(18)

An optical measuring system including:

a plurality of excitation light sources that irradiates a plurality of positions on a flow path through which a specimen flows with excitation rays having different wavelengths;

a solid-state imaging device that receives a plurality of fluorescent rays emitted from the specimen passing through each of the plurality of positions; and

an information processing device that executes predetermined signal processing on the spectral image output from the solid-state imaging device, in which

the solid-state imaging device includes:

a pixel array unit in which a plurality of pixels is arrayed in a matrix; and

a plurality of detection circuits connected to a plurality of pixels not adjacent to each other in the same column of the pixel array unit, respectively.

(19)

The optical measuring device according to (7), further including a detection unit that detects that the specimen has passed through a trigger position located on an upstream side of the plurality of positions on the flow path, in which

the control unit controls the readout on the basis of a detection result by the detection unit.

(20)

The optical measuring device according to (19), further including a trigger light source that irradiates a trigger position located on an upstream side of the plurality of positions on the flow path with trigger light, in which

the detection unit detects that the specimen has passed through the trigger position on the basis of the light emitted from the trigger position.

(21)

The optical measuring device according to (19) or (20), in which the control unit starts the readout after a lapse of a predetermined time from passage of the specimen through the trigger position.

### REFERENCE SIGNS LIST

1, 11, 21, 21A, 21B, 21C, 31 FLOW CYTOMETER
32, 32A to 32D EXCITATION LIGHT SOURCE
33 PHOTODIODE
34 IMAGE SENSOR
35, 36 CONDENSER LENS
37, 37A to 37D SPECTROSCOPIC OPTICAL SYSTEM
371 OPTICAL ELEMENT
50 FLOW CELL
51 SAMPLE TUBE
52 SAMPLE FLOW
53 SPECIMEN
71, 71A to 71D EXCITATION RAY
72, 72A to 72D, 272 IRRADIATION SPOT
73, 273 FORWARD SCATTERED RAY
74, 74A to 74D FLUORESCENT RAY
75, 75A to 75D DISPERSED RAY
76A to 76D, 76a to 76d FLUORESCENCE SPOT
91 PIXEL ARRAY UNIT
91A to 91D REGION
92 CONNECTION UNIT
93, 93a, 93b DETECTION CIRCUIT
93A, 93B DETECTION CIRCUIT ARRAY
94 PIXEL DRIVE CIRCUIT
95 LOGIC CIRCUIT
96 OUTPUT CIRCUIT
100 ARITHMETIC UNIT
101, 201 PIXEL
101a READOUT CIRCUIT ARRAY
111 PHOTODIODE
112 ACCUMULATION NODE
113 TRANSFER TRANSISTOR
114 AMPLIFICATION TRANSISTOR
115, 115a, 115b SELECTION TRANSISTOR
116 RESET TRANSISTOR
117 FLOATING DIFFUSION
118 POWER SUPPLY
121 ROW DRIVE CIRCUIT
122, 122a, 122b CONSTANT CURRENT CIRCUIT
124, 124a, 124b VERTICAL SIGNAL LINE
232 TRIGGER LIGHT SOURCE
233 MIRROR
234 PHOTODIODE REGION
271 TRIGGER LIGHT
S1 RESET SIGNAL
S11, S21, S31, S41 FD RESET
S12, S22, S32, S42 RESET SAMPLING
S13, S23, S33, S43 DATA TRANSFER
S14, S24, S34, S44 DATA SAMPLING
H1 ROW DIRECTION
V1 COLUMN DIRECTION

1. An optical measuring device comprising:
a plurality of excitation light sources that irradiates a plurality of positions on a flow path through which a specimen flows with excitation rays having different wavelengths; and
a solid-state imaging device that receives a plurality of fluorescent rays emitted from the specimen passing through each of the plurality of positions, wherein
the solid-state imaging device includes:
a pixel array unit in which a plurality of pixels is arrayed in a matrix; and
a plurality of first detection circuits connected to a plurality of pixels not adjacent to each other in the same column of the pixel array unit, respectively.

2. The optical measuring device according to claim 1, wherein the first detection circuits are connected to the plurality of pixels having the same number as the number of the plurality of excitation light sources, respectively.

3. The optical measuring device according to claim 1, wherein
the pixel array unit is divided into a plurality of regions arrayed in a column direction of the matrix, and
each of the first detection circuits is connected to one of the pixels in each of the plurality of regions.

4. The optical measuring device according to claim 3, further comprising an optical element that guides the plurality of fluorescent rays to different regions of the plurality of regions, respectively.

5. The optical measuring device according to claim 4, wherein the pixel array unit is divided into the plurality of regions having the same number as the number of the plurality of excitation light sources.

6. The optical measuring device according to claim 4, wherein the optical element includes a spectroscopic optical system that spectrally disperses each of the plurality of fluorescent rays.

7. The optical measuring device according to claim 1, further comprising a control unit that controls readout of a pixel signal from the pixel array unit in accordance with passage of the specimen through each of the plurality of positions.

8. The optical measuring device according to claim 7, further comprising a detection unit that detects that the specimen has passed through a first position located on a most upstream side of the plurality of positions on the flow path, wherein
the control unit controls the readout on a basis of a detection result by the detection unit.

9. The optical measuring device according to claim 8, wherein
the plurality of excitation light sources includes a first excitation light source that irradiates the first position with a first excitation ray, and
the detection unit detects that the specimen has passed through the first position on a basis of light emitted from the first position.

10. The optical measuring device according to claim 9, wherein
the plurality of positions includes the first position, a second position located downstream of the first position on the flow path, and a third position located downstream of the second position on the flow path,
the plurality of excitation light sources includes the first excitation light source, a second excitation light source that irradiates the second position with a second excitation ray, and a third excitation light source that irradiates the third position with a third excitation ray,
the plurality of fluorescent rays includes a first fluorescent ray emitted from the specimen passing through the first position, a second fluorescent ray emitted from the specimen passing through the second position, and a third fluorescent ray emitted from the specimen passing through the third position,
the first fluorescent ray, the second fluorescent ray, and the third fluorescent ray are incident on different regions in the pixel array unit, and
the control unit controls the readout for each of the different regions.

11. The optical measuring device according to claim 10, wherein
the first position, the second position, and the third position are set at equal intervals along the flow path, and
the control unit starts first readout with respect to a first region on which the first fluorescent ray is incident in the pixel array unit when the detection unit detects that the specimen has passed through the first position, starts second readout with respect to a second region on which the second fluorescent ray is incident in the pixel array unit after a lapse of a predetermined time from start of the first readout, and starts third readout with respect to a third region on which the third fluorescent ray is incident in the pixel array unit after a lapse of the predetermined time from start of the second readout.

12. The optical measuring device according to claim 9, wherein the detection unit is a light receiving element disposed on a straight line including the first excitation light source and the first position on a side opposite to the first excitation light source across the first position.

13. The optical measuring device according to claim 9, wherein the detection unit is a light receiving element disposed at a position deviated from a straight line including the first excitation light source and the first position.

14. The optical measuring device according to claim 12, wherein the light receiving element is a light receiving element isolated from a semiconductor chip including the pixel array unit.

15. The optical measuring device according to claim 12, wherein the light receiving element is a light receiving element disposed in the same semiconductor chip as a semiconductor chip including the pixel array unit.

16. The optical measuring device according to claim 1, further comprising a plurality of second detection circuits corresponding to the first detection circuits on a one-to-one basis, respectively, and connected to the plurality of pixels to which the corresponding first detection circuits are connected.

17. The optical measuring device according to claim 16, further comprising a control unit that controls readout of a pixel signal from the pixel array unit such that the first detection circuit and the second detection circuit are alternately used.

18. An optical measuring system comprising:
a plurality of excitation light sources that irradiates a plurality of positions on a flow path through which a specimen flows with excitation rays having different wavelengths;
a solid-state imaging device that receives a plurality of fluorescent rays emitted from the specimen passing through each of the plurality of positions; and
an information processing device that executes predetermined signal processing on output data from the solid-state imaging device, wherein
the solid-state imaging device includes:
a pixel array unit in which a plurality of pixels is arrayed in a matrix; and
a plurality of detection circuits connected to a plurality of pixels not adjacent to each other in the same column of the pixel array unit, respectively.
